(19) United States
(12) Patent Application Publication
(10) Pub. No.: US 2012/0131102 A1
(43) Pub. Date: May 24, 2012

(54) ONE-TO-MANY AND MANY-TO-ONE TRANSFER, STORAGE AND MANIPULATION OF DIGITAL FILES

(76) Inventors: John S. Gabos, Wayzata, MN (US); Christine A. Gabos, Wayzata, MN (US); Kevin C. Hanson, Wayzata, MN (US); Jayson Go, Commerce City, CO (US)

(21) Appl. No.: 13/212,848

(22) Filed: Aug. 18, 2011

Related U.S. Application Data
(60) Provisional application No. 61/374,899, filed on Aug. 18, 2010.

(51) Int. Cl. G06F 15/16

(52) U.S. Cl. 709/204

(57) ABSTRACT

A method of distributing at least one digital file to a group. The group includes multiple group members and is managed by a managing user. The method includes: generating an album for the managing user, the album including at least one digital file by operation of a processor invoking space on an attached non-volatile memory; receiving, from the managing user, data related to the multiple group members; generating, based on the data related to the multiple group members, a copy of the album for each of the group members, thereby creating a virtual album for each of the group members; and linking the copy of the album created for each of the group members to each group member.

### RELATED APPLICATION

The present application claims the benefit of U.S. Provisional Application No. 61/374,899 filed Aug. 18, 2010, which is incorporated herein in its entirety by reference.

### FIELD OF THE INVENTION

The present invention relates generally to methods, systems, and apparatuses for managing the transfer, storage and manipulation of digital files to a network, on a one-to-many and many-to-one basis. More specifically, the invention utilizes computer hardware and software which can be coupled with social network integration and integration with other partners to create a system for the uploading and storing of digital photo and video files and manipulating the organization of these files by its users.

### BACKGROUND OF THE INVENTION

For many years people have sent paper cards and images to a network of contacts for various reasons. Holiday cards sent to friends via a postal service is only one example of this type of exchange. Most recent estimates put the number of holiday cards sent at close to two billion cards per season. The rapid evolution of and the adoption of the internet by individuals has created the opportunity to change the distribution of these documents. While e-cards are created on several web sites such as Blue Mountain, American Greetings or Jib Jab, digital holiday cards have not taken off as socially acceptable. The primary reason for this is that it is not socially acceptable to email out a holiday card.

However, today it is very common for users to upload photos to an on-line web site for display to others. Examples of these sites are Facebook®, Myspace®, Shutterfly®, Kodak® Photo Gallery, Snapfish®, Picasa®, Flickr® and others. On these sites, users are able to upload photos, create albums (grouping of photos) and share these photos and albums with a friend or group of friends. Within these existing sites, the friends with whom these photos have been shared often have rights to upload photos into these albums as well as view them. Several of these sites also have the ability to create and send e-cards via email.

In the traditional online systems mentioned above, the architectures typically allow for a photo to belong in only one album. In order for a photo to be displayed in multiple albums, it must be discretely uploaded to each subsequent album. Therefore, there is a need for an easy method of displaying a particular photo among multiple albums.

Additionally, in the traditional online systems mentioned above, only one representation of each album typically exists. As a result, all users viewing the album share a common view of the photos of the album. However, users can have differing desires for the same album. For example, in an album of three friends' European vacation shared among the three friends, two of the friends visited both Austria and Germany, but the third friend was along only for the Germany portion of the trip. Thus, in a slideshow presented by the third friend to his family, for example, the third friend may want to remove photos in the album relating to the Austria portion of the vacation. In traditional systems, this is impossible without first copying all of the photos to a second album and then manipulating the photos by deleting the undesired photos. Thus, there is a need for uniquely modifying the albums of a particular user without disturbing the same album of the other users.

Users typically have contacts among multiple platforms, depending on the type of contact and the type of platform. The above-listed photo-sharing sites are typically limited by the contacts of the user for a particular platform. A difficulty arises when a user desires to share an album with contacts connected via different or multiple platforms. For example, a user may have one set of contacts connected via Facebook, and a different (and possibly overlapping) set of contacts connected via an address book for the user's email account. It becomes tedious to try and share an album with contacts that are not all connected to the user on the same platform. If an album is created by the user and subsequently shared on Facebook, the contacts of the user not connected via Facebook will need a secondary, non-Facebook means for accessing the album. Therefore, two albums must then be set up. Further, it can be difficult to cross-reference the sets of contacts in order to know which contact should be invited to which album platform. Therefore, there is a need for an aggregator of contacts configured to enable the sharing of photo albums.

### SUMMARY OF THE INVENTION

During the disclosure of this invention, the use of “System” refers to the hardware and software components which comprise the invention, the use of the word “file” refers to a photo image, video file, or document and the use of the word “album” refers to a collection of files. The word “image” refers to the user visual representation of the file and (n) refers to an unlimited number of items.

In an embodiment, the system outlined herein combines separate technologies and applications which are familiar to the users of a system to produce a new system which is optimized for ease of use, rapid adoption and emulates the unique experience each recipient was able to realize with the previous method of distributing paper photos and cards. In one embodiment of the application, off-the-shelf, industry-standard technology is utilized to upload and download photo and video files. One of the uniquenesses of the system is in the management of the distribution of photos (files) to a large number of related users, the relational storing of these photos, the individual repositories or virtual repositories of these files, the rights granted to the users with whom the photos are shared, and the many ways these files can be manipulated, stored, downloaded, and viewed.

In one embodiment of this application (n) number of users will choose to participate in a System where they will identify themselves to each other. In this system, they will indicate their willingness to participate in the file distribution service. Those who have indicated their willingness to participate in the service will set their preferences as to which other members of the service (friends) may receive a file which the user may upload. Once uploaded, the files will be cataloged via a variety of criteria and made available within the service to the other members who are authorized by the uploading user to receive the files. The receiving users will receive all the files from all of their friends into one consolidated location for easy viewing and manipulation but possibly into multiple or different albums based on the user and her friend network's collective use of the system.

Users of the system can invite others to participate by sending invitations through the System, through the System's integration to a social network or other means, including but not limited to: written, digital, verbal, or from within other applications, to the other individuals. Specifically, users may use their network of contacts within a social network to invite users to participate with them within this System. Because the System will be integrated to one or more social networks, a user in the System may configure their settings in the System so that any friend they accept in their social network, who is also a member of the System will automatically be linked to that user within the System. If user has not indicated that all “friends” will receive the files, then a notice can be sent whenever a new “Friend” of that person subscribes to the service and the user can enable connection within the System, one user at a time. Within the System, users can configure the frequency of notification when they receive new files.

As users of the system are likely to have contacts among multiple platforms, including the same contacts across two or more platforms, the system of the present invention is able to effectively aggregate a user's contacts. The system therefore creates a hub for distributing files or albums that readily incorporates the contacts acquired in the various areas of a user's life—business contacts on LinkedIn, social contacts on Facebook, and a mixture of contacts on email—for example. Further, embodiments of the present invention are able to distinguish between two imported contacts that actually identify only a single unique entity. For example, an import of contacts via Facebook and an import of contacts via email address book may both include data on a friend named “John Smith.” In traditional systems, two entries would be created for “John Smith”—one for the Facebook contact, and one for the email contact. This creates contact notification problems. However, the system of the present invention can identify such multiple-but-unique contacts, integrate the data from the imports, and store the contact as a single entry for John Smith, with the option of platform contactability. The system of the present invention thus creates a centralized platform for sending files or albums among all of a user's contacts previously captured only on the respective discrete platforms.

As mentioned above with respect to aggregating contacts, users are able to upload or import their contacts, then select from this list, a list or group of people whom they desire to receive a particular file. Subsequently, the system will match the people data elements entered by the user with other data elements within the System and as may be obtained from the social networks integrated to the System to determine which users on the list are contactable either via the System or a social network, for example. People may be contacted through the system, the social networks, or directly, based on contact information entered or available on the people.

Users of the system are able to apply additional category labels to each of the users in the System with whom they are friends. As an example, categories can be “Family,” “Work,” or an affinity group, etc. There is no limit to the categories a user may create and no limit to the number of categories that can be applied to a friend. The purpose of these categories is for the recipient user to be able to filter and manage the viewing experience of their album.

One of the objectives of the System is to distribute a specific file which may be associated with an occasion. Using a Christmas or holiday card as an example, the system would work as follows. A user will upload one file which is a card that could have been designed on any card design package separate from or integrated to the System. The user will have associated themselves with all members of the system with whom they wish to send the file to, as previously described. Users also have the ability to upload additional photos into their repository or album in the event they receive digital files from friends outside this network via different method or if they wish to digitize the paper cards they may continue to receive and store them together with all of their digital cards within the System. The user may also choose to send a holiday letter (Long Document) which accompanies this file into the system. At the election of the user, the letter may go to everyone who receives the file or may be sent only to members the user has selected, as a sub set of all those receiving the file. The same rules apply for a Short document (“Note”) which is intended as a more one to one embodiment. If there is an accompanying letter, an indicator is presented to the user notifying him of the presence of this document. Clicking on the appropriate indicator presents the letter to the viewer.

On the receiving end of the System, each user will have their own repository or album around this event. All members of the system wishing to send a file to their friends related to this event will end up in an album without the receiving user needing to take any action. These cards are stored in the System so the users may immediately view them without having to copy and paste or upload anything.

While the distribution method of the files is unique and valuable, the manipulation of the Album by the recipients is equally as unique and valuable. Once the files have been distributed to the recipients, that user is free to manipulate the Album any way they wish, without the file sender being aware of how the recipient treats the file. The recipient user may manage the Album by deleting or hiding individual cards, and by setting the viewing order. The recipient user can set the viewing criteria by enabling categories of friends whose card they wish to view. Users are able to save viewing configurations as different play lists for viewing at later times. This independent manipulation hidden from other viewers of the same album is in contrast to traditional albums where any manipulation is necessarily flowed through to all other viewers of the album.

Additionally, the albums can be viewed from within the application integrated within the social network. The albums may also be viewed directly on the System from any device equipped with the appropriate software such as a web browser, and access to the website of the system. A sample of these devices would include but not be limited to PC's, televisions, mobile phones, pad or tablet computing devices.

In one embodiment, the System is integrated to a music service which allows the user to hear music while playing a slide show from within the social network application or from within the site outside the social network. While default sound tracks or playlists will be compiled by the system or by a music service partner who may be integrated to the system, a user may also choose to have a music subscription where they may customize the soundtrack directly.

The System may include client side software that allows a user who wishes to download the files from the system to store them locally on a device in their possession. Once the download is configured establishing which cards are to be downloaded, the system will manage the synchronization of this download information so only the additional files which need to be sent to the local storage are sent, and not an entire copy of the album each time there is a download.

This client side software also has the ability to read other information from the user's local machine to assist with enhancing the user experience. Examples of this information include but are not limited to a user's local music library, video library and Internet favorites. By reading the user's music library, the system can be better personalized via System soundtracks or playlists as well as to inform the user which tracks from their soundtrack they may wish to purchase in order to duplicate the soundtrack locally on their machine.

The system may also be integrated to merchant partners to assist the system users in purchasing items such as photos and other goods that may be associated with the experience. By integrating to merchant partners, the system is able to transfer a file which a user has uploaded to the System directly to one of these merchant partners. Additionally, an integrated merchant partner may also upload a file (photo) on behalf of a user.

The System also has a component where a subset of the members may elect to create an album and this subset can contribute files into this album. For the ease of explanation, these will be referred to as “Group” albums. The concept of a group album is not entirely unique as it exists on most of the current photo sites mentioned previously. A uniqueness of the present invention not found in the above-mentioned sites relates to the user manipulation side where all of the album manipulation capabilities previously mentioned are available for a user to take the files contributed and arrange them to create an experience unique to each user. There are configurations where multiple files can be contributed or where only one file can be contributed. One other difference in the group album configuration is that an accompanying letter may be contributed to by all members of the group. From a viewing perspective, each member may elect which specific contributions to this document they wish to view. The soundtrack or playlist capabilities apply to group albums as well allowing each user to create their own sound experience regardless of what the other Group album members elect to do.

In an embodiment, users have elected to join the system with the capability of uploading a file to be shared with other members of the system. The design of the system allows for any single user to upload a file. Once the file is uploaded, (n) number of system users as selected by the individual uploading the file, may be the intended recipients of the file. The system will create a separate repository (album) within the system where each user's files which are delivered from other numerous users will be catalogued and accessed for their usage. Once these files are shared with the system, the intended recipient users will be able to interact with and view the files. As a point of clarification user A uploads a file, file ID xx. User A has 200 friends with whom he would like to share the file. Only one copy of file xx is stored on the system. User B is on the recipient list of User A. User C uploads file yy and user B is also on the recipient list of user C. Inside a user's repository is a listing of the files which are designated for the specific user's repository. So in the repository for user B, she has references to file xx and file yy. In the preferred embodiment of the application the actual file is not duplicated into each recipient repository because this method is less efficient from a data storage perspective. Operators of this system could choose to store duplicate copies of the file if storage costs were not a concern.

In an embodiment, a user account in the System is created for a person when they either create one on their own, or if their information is imported into the system or added to the system by a currently registered active user. The user status is “Active” if they have entered in the required data elements using the user interface as shown in FIG. 9. The user status is “Temporary” if the account was created as a result of the user being imported into the system or being manually added, and the user status is “Viewed” if they have authenticated into the system to view files which have been sent to them but they have not completed the required user information in order to activate the account. A single person can be known by many different people, several of whom may import this single person into the System. The System uses individually identifying information including but not limited to; e-mail address, and userIDs from other external system partners (for example, Facebook User ID or LinkedIn user ID) in order to identify a person being imported as a current user and someone who does not need to have a new account created into the system.

In an embodiment of a system, the system is integrated with one or more social networks and can utilize existing relationships mutually agreed upon by the parties within those social networks. As an example, within Facebook, two individuals have mutually agreed to be friends. If each user joins the system using the system interface for Facebook, those same two users are now linked within the system and will automatically receive a file if they are eligible as per conditions set by the file submitter. However, the system is not dependant on integration to a social network.

In an embodiment, the user has imported their contacts from an online contact system they have been using, including but not limited to, sites such as Yahoo, gmail or AOL, and or the user has also imported their contacts from other contact organizing applications including but not limited to such as Outlook or Lotus Notes. Now these contacts are held in the System. In this embodiment where the System is connected to the Social Networks or external systems, the System can import the Social network ID for these contacts. While the popular Social Networks have “friend finder” applications and a user may import this same contact list into the social network to find these friends, a meaningful benefit of the System is that because the System is integrated to the social network, the system is constantly checking the System user's list of contacts against the list of users in the social network and identifying these contacts within the social network as soon as these new contacts join the social network, thus eliminating the requirement for System users to repeatedly and periodically manually perform this step to find out if they have any more contacts who have joined this social network.

In an embodiment of the System when the System user is looking at the view of their contacts, icons are displayed for the specific social networks indicating that this contact has been located within the social network. This icon may be represented in different ways such as different colors to further indicate whether the System user is linked to this contact in the specific network. Clicking on this Icon will launch a separate browser instance and connect to the social network, thereby displaying the page for this contact. The System user may be required to have his own account in the specific Social Network in order to view this page. In an embodiment, this contact's social network page may be displayed within our application.

In an embodiment, the system is able to add multiple levels and elements of additional filtering both for file distribution and file manipulation based on, both data elements entered into the system by the users and data elements obtained from the social networks, to more specifically manage the distribution of files.

In an embodiment, within the system, an album owner has the exclusive rights to manipulate what is viewed within the album and the viewing order of the files. So this user can hide files, delete files, and change the viewing order. Even though others may feel they share this album they really only share their virtual copy of the album which others have contributed to. A user manipulating their album is a private event. Other system users who have shared files to the user who is able to manipulate the album will not be aware of the actions this user has taken. As an example, user A may upload a file to be eligible to be in an album which is now owned by user B, if user B deletes this file, user A will not know.

In an embodiment, the user may view the album and its associated files in a variety of ways. Examples include but are not limited to; as individual images, as a slide show as a collection of thumbnails, as a collage.

In an embodiment, when a user uploads a file into the system, it can be assigned to go to all of their friends or the user may elect to share the file with only a subset of the users with whom they have a friend relationship within the system.

In an embodiment, within the system, a user has the ability to categorize the other members of the system with which they have a relationship, examples of this categorization could be, friends, family, business associates etc. these system members may be categorized in more than one category. For example, they may be a “friend” and may also be a “family”. As a result of this categorization, the files themselves have the ability to be categorized.

In an embodiment, a file when uploaded can also be categorized. For example, a photo could be categorized as a holiday card, Graduation card etc.

In an embodiment, a method where files from one album may be combined with files of another album, so that users who do not share an identical list of friends may combine their albums for a single user viewing experience. This combining of albums can be a one direction synchronization moving files from one album to another. Another synchronization option can be bi-directional, synchronizing both albums creating two albums containing an identical list of files. The process of combining more than one album will require one system user to send an invitation to a second user which that second user must accept prior to this synchronization process being enabled. Once these albums are joined, any files subsequently added to an album will be synchronized appropriately.

The System is designed to take multiple identifying user elements including but not limited to: e-mail address, and userId's from other external system partners (Facebook User ID, LinkedIn user ID as examples) in order to identify a person being imported or manually added. Given that a single user may have multiple elements, such as two different email addresses, two people may choose to share one album by verifying two email addresses one from each different person into the same system account. The same is possible verifying more than one account from the same social network or external system.

In an embodiment, subject to the attributes which can be associated with a file, a user may choose to filter the album showing only a subset of files eligible for this album. The owner of the album may filter this album based on a variety of the criteria controlling not only which files are visible in the album, but the order these files are presented during viewing. Examples would include but not be limited to a user electing to only view the files from “users who have the category “family” and no other files in the album.

In an embodiment, a method where a user can create an album where they can elect to view the files submitted by a user or multiple users not from a specific album that may span multiple albums such as all the “Gabos” family Holiday cards that have been submitted over the years.

In an embodiment, users who choose to filter their album may save the album with these filters applied or may elect to save only a version of the album as a playlist. A similar example to this would be how a user can save a playlist with their music library.

In an embodiment, a method for managing an album where there is more than one member of the system entitled to manipulate this album (Group album). In the event there is more than one member of the system entitled to manipulate the album, a second album ID will be created for each additional member of the system entitled to manipulate this album. Each member will be entitled to have their own version of the group album so all files uploaded by all members will be in a virtual album controlled uniquely by each member.

In an embodiment, while it will be an objective for the files which are contributed to the system to be submitted by users of the system intended for other users, there may be users of the system who are sent files via digital medium such as email which did not come from other members enrolled in the system and not sent within the system. This system allows the user to add files to the system via an automated method by forwarding on the email to an account managed by the system. The user may also upload a file utilizing a manual process for placement into an album which they control.

In an embodiment, some users who upload a file to be distributed to other users may wish to upload an accompanying letter to be distributed to other users. When a user does this, the relationship is denoted with an indicator within the system, clicking on indicator displays the letter. This indicator mark is only visible within the System itself. This letter would be intended for more than one user but not necessarily everyone who was entitled to view the file. The System will track that one letter was uploaded, but it is eligible for a specific list of users who are also eligible to view this file. This list of users eligible to receive the letter may not include everyone who was eligible to receive the accompanying file.

In an embodiment, a user may upload a personal note (short document) to accompany a file. This relationship will be denoted with a visible indicator mark. If there is an accompanying letter, an indicator is presented to the user notifying him of the presence of this document. Clicking on the appropriate indicator presents the letter to the viewer. This indicator is only visible within the System itself. A note intended for only one other user of the system would be most representative of this feature. In another embodiment, indicator marks are not actually applied to the face of the image, but only visible within the System itself. Images downloaded from the system will not be able to display this mark.

In an embodiment, if the Album is classified as a “group” album, the Letter is editable by all members eligible to be in the group. Each remark entered is catalogued by the person making the remark and the date of the remark. Within the album, the viewer of the album can further edit the document for their own viewing preference hiding or deleting some of the remarks from their own view.

In an embodiment, a user may upload an audio file which accompanies a file. This relationship will be denoted with a visible indicator mark on face of image, clicking on image will play the audio file. This indicator mark is not actually applied to the face of the image but only visible within the System itself.

In an embodiment, a user may upload a video file which accompanies a file. This relationship will be denoted with a visible indicator clicking on the indicator will play the video file. This indicator mark is only visible within the System itself.

In an embodiment, if a system user has uploaded a file for distribution and has indicated they want it distributed it to “all Friends”, then, if two people establish a relationship as friends after the file has been distributed, this will trigger the delivery of the file to that additional person. A new user to the system becomes eligible to receive a file only when a previous user of the system grants this right. An example of this can be when an existing user accepts the new user as a friend in one of the social networks integrated with the system.

In an embodiment, users can have more than one account in the system either because they created it with a different email address, or because an account was created for them by the System when a user added this person to the system with a different email address or a different social network or external system ID than the one presently in the System.

In an embodiment, users who have activated themselves within the system may combine accounts for one visible viewing experience. So multiple contact points such as email address or phone number may be listed for a user account.

In an embodiment, users of the system will be able to access and interact with their files from within the interface for the social networks. Example, users who have joined the system from within a social network may interact within the system from within that social network and interact with their files which they may have uploaded into that social network or third party file storage site, where allowable by those sites. Where allowable by the social network, the user of the system will be considered authenticated into their account within the system as long as they have authenticated to the social network.

In an embodiment, while the preferred embodiment of the system leverages the integration to social networks, users will be able to access and interact with the system directly without entering the social network. As an example a user can log into the system by accessing the web page and entering in their credentials they have elected to use with the system. Examples of this include but are not limited to internet connected devices such as PC's, Web enabled Televisions, mobile devices tablet and pad computers.

In an embodiment, users of the system will be able to configure the system to download the album and its inclusive files to a storage media outside the system. Examples of this include but are not limited to; downloading to a computer, digital picture frame, mobile device such as a phone.

In an embodiment, the system may contain a library of audio files which can be played while the album and its associated files are being viewed.

In an embodiment, the system may provide integration to an external service which offers a collection of audio files which can be played while the album and its associated files are being viewed. If the album and its inclusive files are downloaded to a storage media outside the system the user may be able to download and save audio files which have been associated with the Album.

In an embodiment, the upload and download interface module to the system will be configurable by the user so as to allow the module to communicate information back to the system about the content on the user's local computing device. Examples of this would include but not be limited to, listing of albums and associated files which have been downloaded, contents of a users music and video library which can be uploaded to the servers to provide more information on user interests.

In an embodiment, The System produces a file such as can be used as an album cover. This file exists within an on line system but can be exported outside the system.

In an embodiment, integration to third parties from which the users could order photos and merchandise is a service of the System and which same third parties may contribute files to these users' accounts.

In an embodiment, a system of managing digital files for managing the transfer, storage and manipulation of digital files to a network, and on to individuals, on a one-to-many and many-to-one basis as substantially described herein, and including a user interface, social networking application, and a server storing user data.

In an embodiment, a method of managing digital files for managing the transfer, storage and manipulation of digital files to a network on a one-to-many and many-to-one basis, as substantially described herein.

In an embodiment of the system, the platform the cards and files send may be for a variety of purposes including, but not limited to greetings, announcements, messages or invitations. On the occasion that a sending event is an invitation, the system is further designed to perform the tracking of RSVP responses from recipients.

In an embodiment, the System can use multiple notification methods to invite these users, the System may send email or text message if direct contact with this friend is possible with the data held in the system, or the system may use the notification channel supported by the integrated Social Network partner if that pathway is available.

In an embodiment the system may be integrated into other applications or platforms where users have already been aggregated to interact with their contacts or Friends. Examples of these systems would be CRM portals such as Salesforce.com, and similar functioning private enterprise portals used by a specific company.

In an embodiment of the System, a user may edit the display name and photo for their contact regardless of the name and photo this friend may be using within a Social Network, without affecting the name and photo presented to any other user of this System for this same contact.

In an embodiment of the System, only the person who has uploaded a contact or imported a contact from a Social Network is aware of that contact person's presence in the System. In this embodiment the System is not an alternative social network which may be searchable by users looking for people to establish new relationships with. The system uses all information within the system to validate users, but this information is known by the System and not made available to the users.

In an embodiment, a user's network of friends is derived from the users that such user added singularly (via “Manual Add” functionality), in bulk (via “File Import” functionality) or by the system importing your friends from social networks. Such network of friends is private by default. Therefore, the list of friends in the network, and the friends-of-friends themselves cannot be viewed by others when the “private” setting is enabled. However, this setting may be altered by modifying the visibility level of the privacy settings to allow for the exposure to other users of the relationships a particular user has with other users.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a high-level system overview which shows relation of System users and their various access methods to the System and the partners working with the system, according to an embodiment;

FIG. 2 is a diagram of internal System components and their functions along with functions of external components, according to an embodiment;

FIG. 3 is a master table showing relevant data elements for System Users, according to an embodiment;

FIG. 4 is a master table showing relevant data elements for Friends, according to an embodiment;

FIG. 5 is a master table showing relevant data elements for Files, according to an embodiment;

FIG. 6 is a master table showing relevant data elements for Albums, according to an embodiment;

FIG. 7 is a master table showing relevant data elements for Document, according to an embodiment;

FIG. 8 is a master table showing relevant data elements for Categories, according to an embodiment;

FIG. 9 is a User Settings Screen, according to an embodiment;

FIG. 10 is a User screen for Manage Friends/contacts, according to an embodiment;

FIG. 11 is a User Screen for Manage Cards, according to an embodiment;

FIG. 12 is a User Screen for Create Long Documents (Letters), according to an embodiment;

FIG. 13 is a User Screen for Manage Short Documents (Personal Note), according to an embodiment;

FIG. 14 is a User Screen for Presenting Documents (Letters and Notes), according to an embodiment;

FIG. 15 is a User Screen for Edit Albums, according to an embodiment;

FIG. 16 is a User Screen for Manage Albums, according to an embodiment of the present invention;

FIG. 17 is a User Screen for Merge Albums, according to an embodiment;

FIG. 18 is a User Screen for Letter in Group Album, according to an embodiment;

FIG. 19 is a depiction of Manage Categories, according to an embodiment;

FIG. 20 is a Letter in a Group Album according to an embodiment;

FIG. 21 is a portion of a database schema illustrating tables related to a user and a user's role, according to an embodiment;

FIG. 22 is a portion of a database scheme illustrating tables related to contact relationships, according to an embodiment;

FIG. 23 is a portion of a database scheme illustrating tables related to messaging, according to an embodiment;

FIG. 24 is a portion of a database scheme illustrating tables related to albums and files, according to an embodiment;

FIG. 25 depicts a flowchart of a method of managing an album, according to an embodiment;

FIG. 26 depicts a flowchart of a method of managing a group album, according to an embodiment;

FIG. 27 depicts a flowchart of a method of sharing in a group album, according to an embodiment; and

FIG. 28 depicts a flowchart of a method of user reconciliation, according to an embodiment;

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Before describing in detail some of the particular uniquenesses in accordance with the present invention, it should be observed that the present invention includes a novel structural combination of conventional computer hardware and networks and conventional; file uploading, storing, cataloging, manipulating, viewing, playing, downloading technologies and industry accepted techniques for large scale computing system performance and not in the particular detail of the high level configurations therein.

Accordingly, the structure, control and arrangement of these conventional hardware and software components and technologies have been illustrated in the drawings by readily understandable block diagrams which show only those specific details that are pertinent to the present invention, so as not to obscure the disclosure with structural details which will be readily apparent to those skilled in the art having the benefit of the description herein. Thus the block diagrams illustrations of the Figures do not necessarily represent the mechanical structural arrangement of the exemplary system but are primarily intended to illustrate the major structural components of the system in a convenient functional grouping, whereby the present invention may be more readily understood. Several of the figures also detail data elements which are relevant for the association of members of the system to each other and to the files which are managed by the system. The figures do not contain a listing of all data elements managed within the system, only the ones necessary for disclosing the invention. The names of the tables and names of the elements may be modified in the deployment of the system, it is the presence of these elements, their appropriate relationships to each other and the defined functions as spelled out which is relevant to the invention.

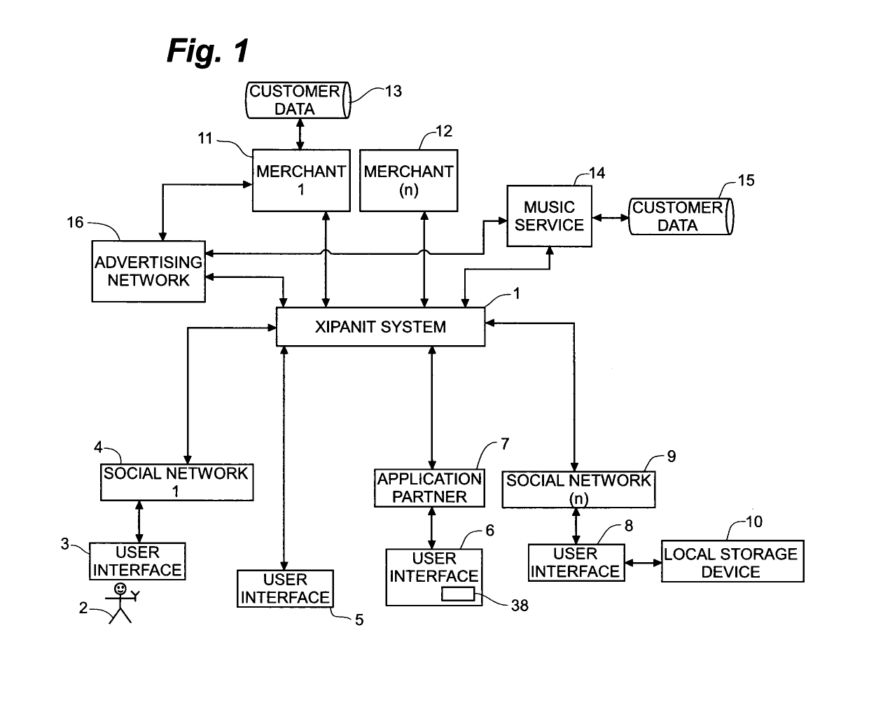

In an embodiment, referring to FIG. 1, the System 1 is at the center of connecting the users 2 to the file sharing experience. The user interface 3 includes any device capable of being connected to the internet. Examples of this user interface include but are not limited to a computer, Tablet PC, Pad PC, television or a mobile device such as a phone. The user can connect to the System through an application which is part of a social network 4 or the user may connect to the system directly as shown by the connection of user interface 5. User interface 6 represents a scenario where the System is integrated with an application partner or website 7 which is not considered a social network. User interface 8 is a representation to show the system is capable of being integrated with more than one social network 9. User interface 8 also displays a scenario where a user will download files from the system and transfer them to a local storage device 10 which may also be capable of displaying the files as images. The System is also designed to be integrated to merchant partners 11 for the purpose of connecting the users of the system to the merchant to facilitate business between the users and the merchant. In FIG. 1, with the representation of merchant 11, it is illustrated that the merchant may be directly integrated with an advertising serving partners 16 whereby it uses a cross reference of the user's information with information it holds on this same user in its own data repository 13. Merchant 12 is representative of a partner who is not linked into the System's advertising system. The System is designed to be integrated with a partner service 14 which plays or sells digital music. This partner will furnish music which can be integrated with the users viewing experience while utilizing the service. This music partner 14 may also be integrated with advertising serving partners 6 whereby the advertising serving partner 6 uses a cross reference of user information with information the advertising serving partner 6 holds on this same user in a data repository 15 of the advertising serving partner 6. An element of the application is a piece of software which can read a music and video library located on the user's local machine. This information can be passed to the music partner 14 in order to drive more personalized music and video experience.

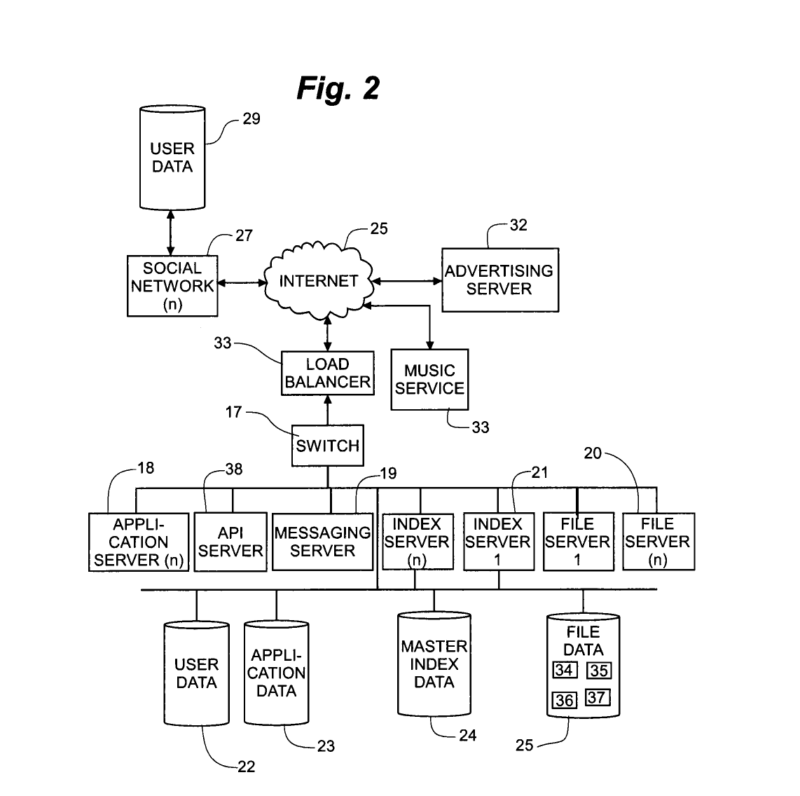

Referring to FIG. 2, Users 2 will connect to the System 1 using any of the capable user interfaces 3 via the internet 26 or any succeeding means if one manifests. The applicable connection method will pass through the load balancer 33 where traffic will be directed appropriately within the System. A switch 17 connects the internal components of the system to each other. A pool of application servers 18 are representative of the machines which receive the user requests and call on the System internal services to perform the necessary actions. Application servers 18 can each have, in embodiments, a processor configured to receive user requests and non-volatile memory, such as random access memory (RAM) or read-only memory (ROM) configured to store the algorithms described herein in the form of machine-readable code. All herein-described servers may be physical, or virtual machines or simply multiple services on the same physical machine.

In the event the user is connecting to the System through a social network partner 4, 9, the request will be passed through an API server 38. The application servers 18 will retrieve the necessary information by authenticating the user against information in the user database 22. Once authenticated, the application server 18 will establish a session with the Index servers 21 which will retrieve a copy of the user's complete index file from the master Index database 24. Index servers 21 each have, in embodiments, a processor configured to manipulate the master index database 24 and non-volatile memory such as RAM or ROM configured to store the manipulations described herein in the form of machine-readable code.

The master index database 24 holds all the relevant user and file relationships. The index servers 21 track the session information, managing the requests and posts from the various system components, and update all appropriate files as a result of the actions the users and system partners perform. The index servers 21 communicate with the system components, such as the application servers 18 and the Application database 23, the application servers 18 and the File servers 20.

It will be understood that the data of the various databases described herein may be stored in a variety of data store types, including relational, table and blob storage. In an embodiment, binary data (image files, documents, videos, etc) in particular may be stored in a blob storage (which is not a relational data store). This may be advantageous because blob storage is specifically designed to store large numbers and sizes of binary data, which in some cases is what the scalable system of the present invention requires. In some embodiments, certain data may be stored will be in table storage. Table storage is a structured data store but is not relational. Both blob and table storage use the same underlying persistence system, which is highly scalable. As such, the system of the present application is able to grow to millions of users without needing to refractor the storage layer like other known applications apps that grew in size too fast.

File servers 20 each have, in embodiments, a processor configured to manipulate the files held in the clustered file database 25 and non-volatile memory such as RAM or ROM configured to store the manipulation algorithms described herein in the form of machine-readable code. The files handled by file servers 20 are any items loaded into the system by users. These include but are not limited to digital images 34, videos 35, long documents (letters) 36, short documents (notes) 36, and audio files 37. The System is also integrated to one or more social network 27 via the API server 38 and may access information made available through these social network specified protocols about the user in each session from the Social network database 29 and that user's files. The system may also access information about all other users within the System 1 in this social network 27 system database 29 as per the unique requirements and permissions of each individual social network partner. The system is also integrated to one or more advertising serving partners 32 using the API server 38, in order to present advertisements to the users during their session. The System 1 is also integrated to one or more music service partners 33 using the API server 38 in order to offer this experience to the users.

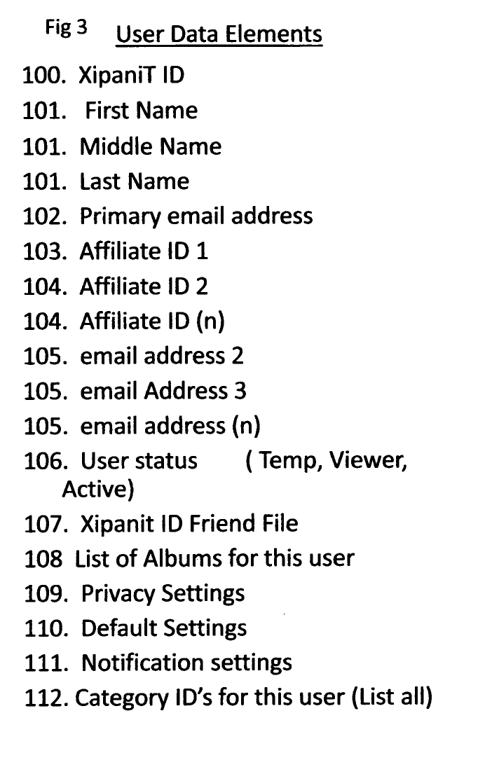

FIG. 3 lists data elements stored within the System related to a System user. In an effort to keep the disclosure as clear as possible, the System elements will be referred to with the word XipaniT, which would represent a possible name for the System.

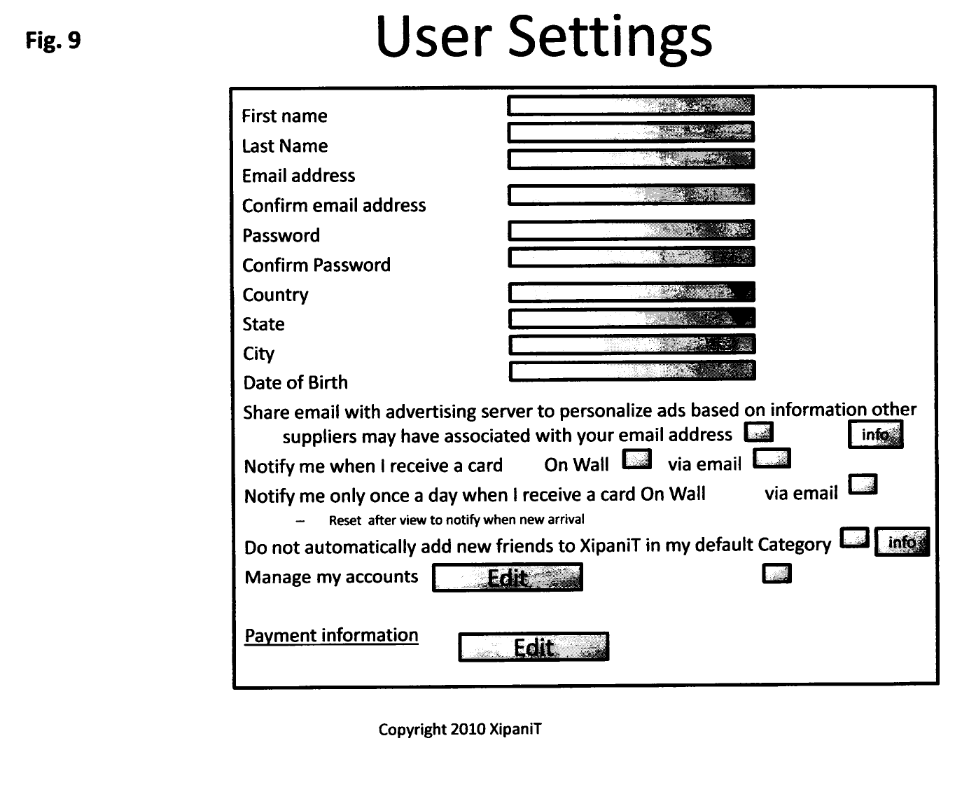

The XipaniT ID 100 is the identification element for a particular user within the System. This element is unique for each user. The user name 101 identifies this user and will be displayed to other System users throughout the System when that situation is required. The Primary email address for this user 102 is the preferred method of communication between the System and this user. This element may have been entered into the System; by this user, may have been obtained from partner systems such as represented in FIG. 1 items 4, 7 and 9 or may have been uploaded by a user who is importing a list of his contacts. This email address element may also be a number such as is presently known today as a mobile phone number if this device is capable of receiving these type of communication messages. As mentioned, within the System there is a provision for the user to have more than one email address, these elements 105 allow for the user to combine multiple email addresses into their System account. This would be common for an individual who has a work email address and a second email address which the user may use for more personal communication. As was mentioned the System is designed to interface with other systems such as social networks. Element 103 and 104 are Identification numbers the system holds that are the identifier for that user in the other systems. Element 106 identifies the status of a user within the System. A user account in the System is created for a person when they either create one on their own, or if they are sent a file (card) by a currently registered user. The user Status is “Active” if they have entered in the required data elements using the user interface as shown in FIG. 9. The user status is “Temporary” if the account was created as a result of a user being imported or manually added by a friend into the system by an active user and the user status is “Viewed” if they have authenticated into the system to view files which have been sent to them but they have not completed the required user information in order to activate the account. Element 107 is the file ID containing a listing of all XipaniT friend Identification numbers for the other System users who have a relationship with this user. Element 108 is a listing of all the individual XipaniT Album identification numbers which this user is entitled to interact with. Element 109 represents the Privacy settings selected by this user. Element 110 represents the default System settings selected by this user. These settings relate to how this user would like the system to automatically behave when their Friends takes actions with respect to creating albums and submitting files additionally these settings relate to how this users viewing experience will be presented when they are using the System. Element 111 represents the settings a user would select with regard to how and how often they are notified of events which happen in the System that affect their friends or files. Element 112 represents XipaniT category identification numbers. A category is an attribute which can be assigned to a member or file for the purpose of additional filtering. These categories may be created by the system user or may also have been obtained via the Social network partners as previously described.

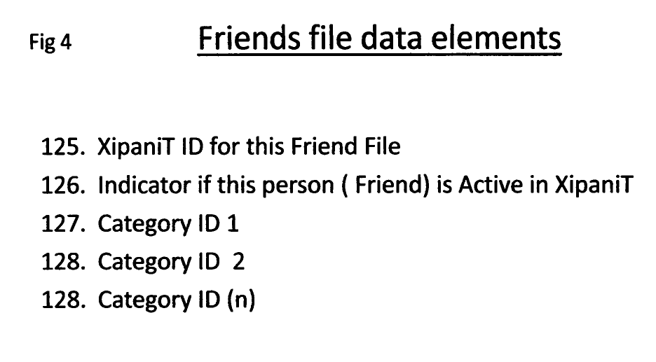

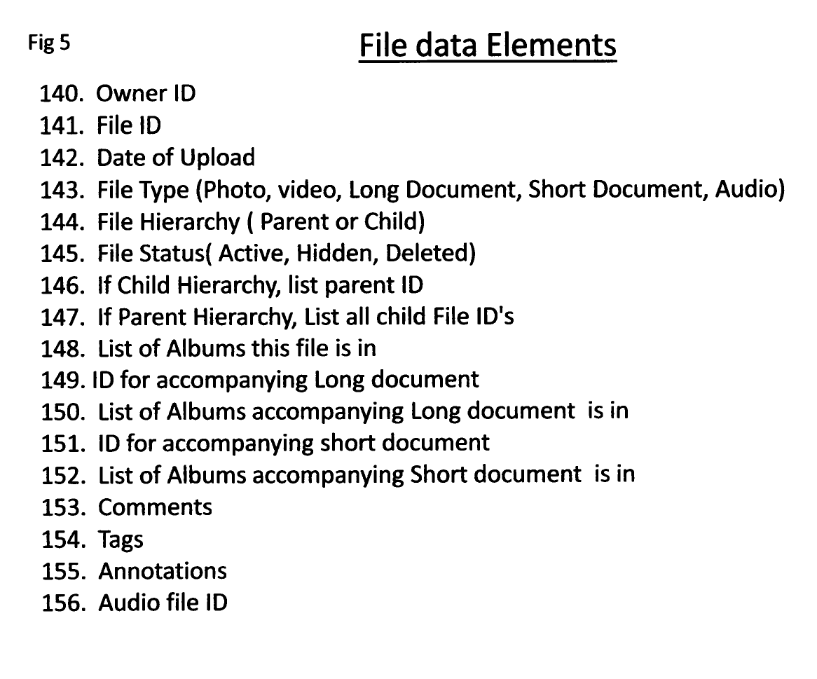

FIG. 4 lists data elements stored within the System related to the Friends who a particular user has a relationship with. Element 125 is the XipaniT identification number for the file which holds all of the friend references for this user. Each user has their own “Friend” file. Element 126 is a status indicator identifying if this user has activated their XipaniT account. Element 127 is a category identification for a category ID which this user has assigned to this friend or has been obtained from a Social network partner. Category relationships are not mutually exclusive. A friend can be in any number of categories which a user assigns them to.

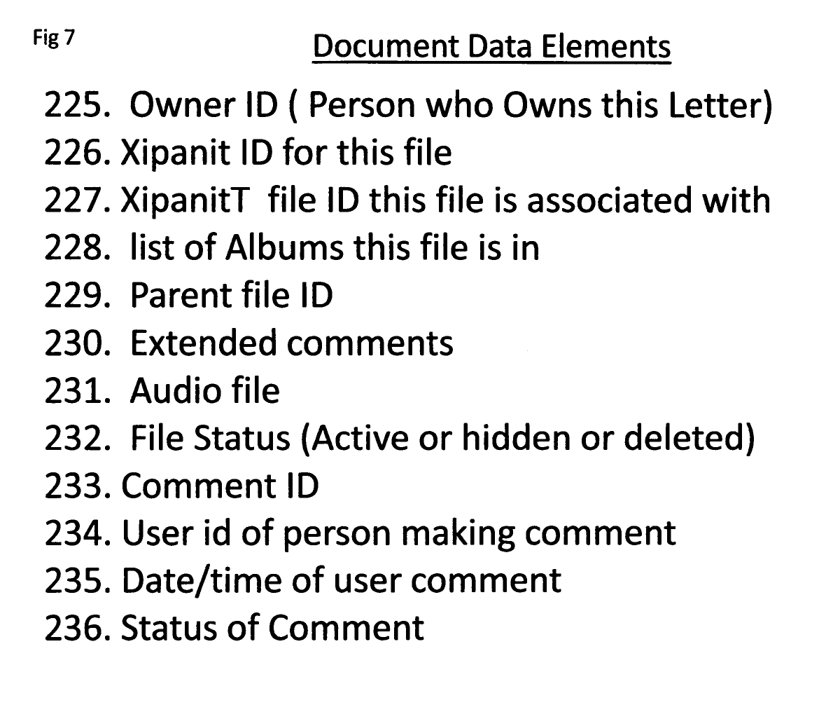

FIG. 5 lists data elements stored within the System related to the Files which are uploaded to the system. Element 140 is the XipaniT identification for the owner of the file. This is the individual who uploaded the file to the System. Element 141 is the XipaniT identification for the specific file. Element 142 is the date the file was uploaded to the System. Element 143 is a descriptor identifying the type of file which has been uploaded, File types presently include Photos, videos, long document, short document, and Audio. The System is designed so that if different types of files are created or become standard in the future, they can be managed with this System. Element 144 indicates the hierarchy of the file. A file is a “Parent” if it is the original file uploaded to the System. As an example a user uploads a photo file to the System and a XipaniT id is assigned to this file. The System user then distributes this file to one hundred different friends. One hundred different XipaniT file ID's will be created for the instance of this file which is then placed in a virtual album of each of the one hundred friends. These one hundred new XipaniT File ID's are of the “Child” type and are linked to the parent file 147. Because these one hundred files are children of the original file, they will hold a reference to the parent file as data element 146. In an embodiment of the system, one hundred additional copies of the original uploaded file are not stored. The System is actually capable of duplicating the original file one hundred times, but this is not the most efficient way to manage the storage of a very large number of files. Each user of the System has the ability to control the experience within their Albums. A user may view all the files within an album or the user may hide or delete these files. The file status is tracked via element 145. Element 148 is a listing of all of the Album identification numbers this file 141 is listed in. In the preferred embodiment of the System, a user has the opportunity to send a document along with a Photo file they have uploaded to the System. An example of this would be a Holiday letter a user would send along with the Holiday card picture. Element 149 is the XipaniT identification number for this accompanying document file. FIG. 7 goes into more detail on the handling of these types of files. If the file type is a long or short letter there is more information held in a document file 36. Long and short document files are treated differently than Photo or video files as these are files which accompany a photo or video file. Document element 150 tracks the status of this file within an album, the user may hide or delete these files. Element 150 is the list of XipaniT Album identification numbers of the albums the long document is affiliated with. This long document is intended as a document which is sent to a number of people. A second type of document 151, referred to as a short document or note, is intended for a one-to-one message where the user is sending a document only to one other user or a small number of users.

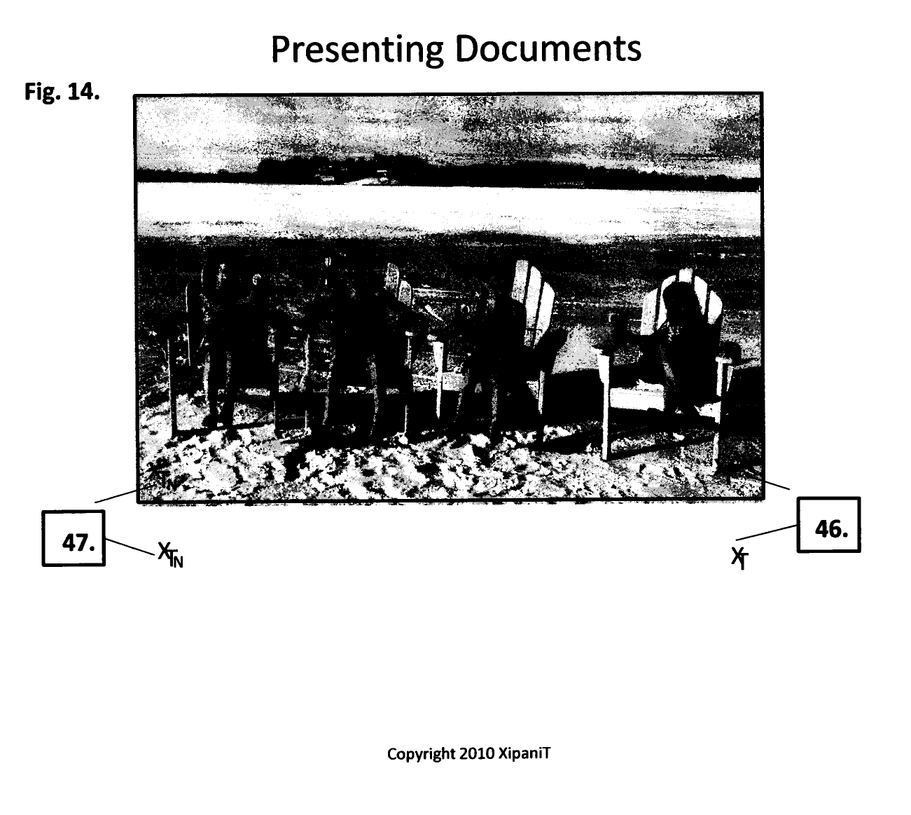

Element 152 refers to tracking a list of all the albums this short document 151 is viewable in. The presence of element 149 and 152 will cause the System to present a visual indicator to the user of the system when she is viewing a file which has one of these accompanying documents. FIG. 14 illustrates this feature in more detail. Items 153 Comments 154, and Tags 155 annotations refer to elements which one of the system users has entered into the system that relate to a file. If the album is not a group album then the elements may only be entered by the user uploading the file. If the file is in a group Album then any member of the group can enter these elements and they will be so noted within the System. Item 156 indicates the relationship of an Audio file which has been uploaded into the System and is associated with a photo or video file. The presence of this file will be made known to the System user with a visual element similar to those described as elements 46 and 47 on FIG. 14.

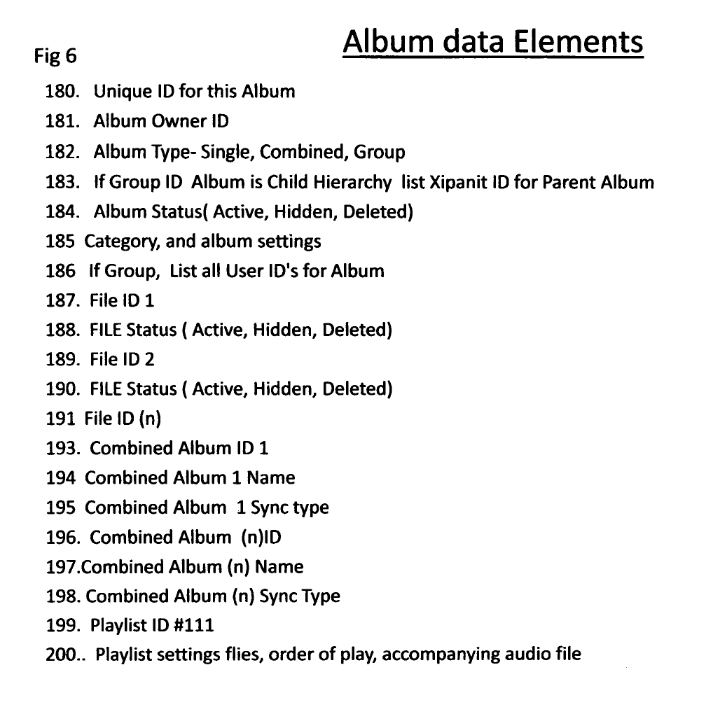

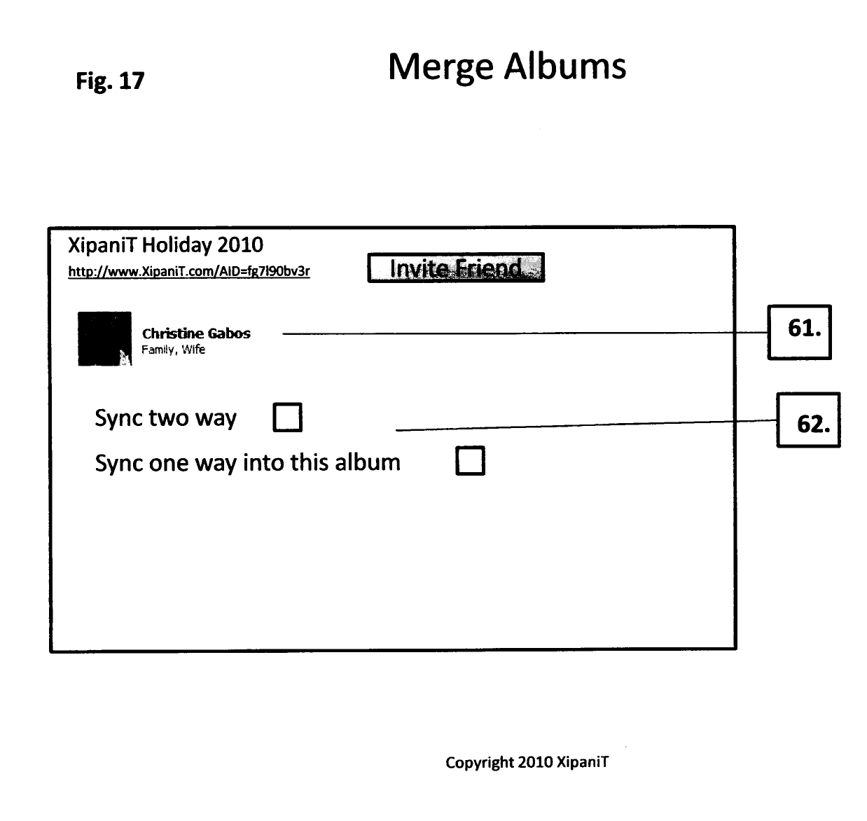

FIG. 6 outlines the album data elements stored within the System. Each album has a XipaniT Id 180 which is unique within the System. There is an Album owner 181 which has the rights to manipulate the album. Element 182 indicates if the album is a single, combined or group album. If an album is a group album, it is a child to the parent album 180 is it's unique ID and element 183 will be the reference to the parent album. Element 184 records the album status as “active,” “hidden,” or “deleted.” Item 185 is a listing of all the album settings including as which Categories are being viewed. If the album is a group album, element 186 will list all of the XipaniT user identification numbers for the users who are eligible to interact with the album. As referenced in the discussion of FIG. 5, the particularly unique enablement of the invention is that each user who is in this group album actually has their own album ID for this group album so while a member of a group album, a member actually manages a virtual album controlling the experience they wish, hiding and deleting files without affecting what the other members of the group see. So all members may contribute files and each member controls the appearance of their own version of the album. As an example, user A uploads five files and User B uploads ten files. User A chooses not to view two of the files uploaded by user B. Thus user A either hides or deletes the two files. The Album that user A sees has the five files uploaded by A and the eight remaining files uploaded by B. User B wishes not to view one of the files uploaded by A so user B hides or deletes the one file. The Album viewed by B has the ten files uploaded by B and the remaining four uploaded by A. If a user hides a file it remains in their album but is not visible until the user elects view hidden files. If the user deletes a file, they may not view it at a later time. Elements 187, 189, 191 display different files which are available in this album and a status element 188, 190 associated with each element. Element 193 is an album Id which has been combined with this album. In this instance two or more users have agreed to combine at least two albums for a single viewing experience. The actions surround this combination are covered in more detail in FIG. 17. Element 194 is the album name for this second combined album, Example “Tina Gabos Holiday 2010” element 195 indicates the Sync relationship between the albums. From the invitee into the inviter or as two way, synchronizing both to create two identical albums. Element 196 is the XipaniT Id for this second Invitee album.

Items 196, 197, 198 are present to show more than two albums may be combined. If the albums are combined as mentioned here, each album owner still possesses the ability to filter out the files from the additional album as referenced in the discussion of element 185. Element 199 is a recording of the settings a user has selected when they created a play list for a particular Album. This playlist lists the files in the order the user would like to view the files.

FIG. 7 discloses the data elements stored within the System with respect to files which are documents. Element 225 is the XipaniT ID for the file owner. Element 226 is the XipaniT ID for this file. Element 227 is the File ID this file is affiliated with. Element 228 is the list of Albums this fileis in. Element 229 is the Parent ID for this file which exists if this file is in a group album. Element 230 is the actual text of the file which include all text formatting information. Element 231 lists a XipaniT file ID for an audio file which may be affiliated with another file such as a photo or video 227. Item 332 is the status of the file; active, hidden or deleted. Item 233 comes into play commonly when the file is in a group album. Each user may edit this document and item 233 records a comment ID for this remark so it can be managed by each viewer of the file. Element 234 is the XipaniT ID for the user making the comment. Element 235 is the time/date stamp for the comment. Element 236 is the status of the comment, which is managed by each user to control their version of the document. The status may be active, hidden or deleted.

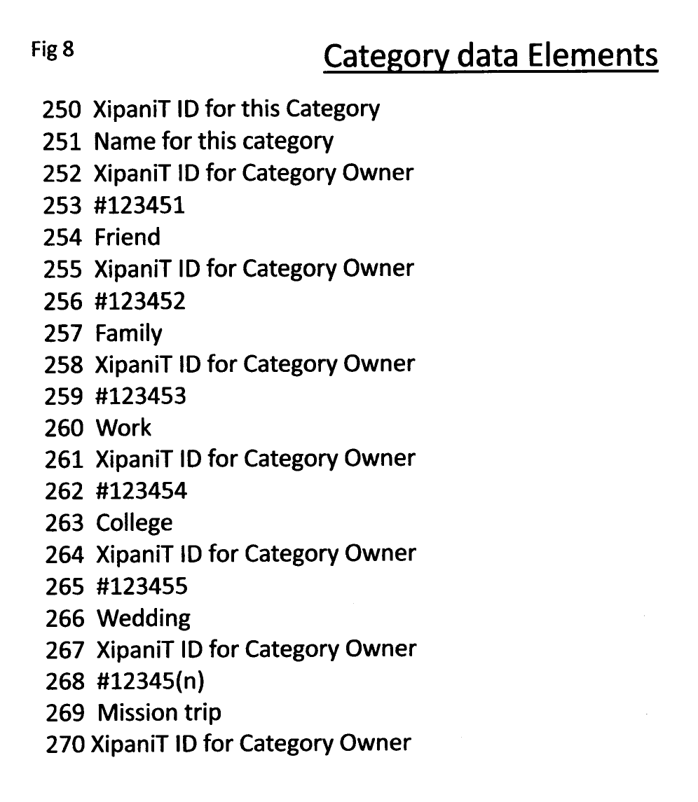

FIG. 8 discloses the category data elements stored within the System. Element 250 represents a category identification number. There will be default categories within the System as represented by Categories 250, 253, 256, 259. These category ID's are the same for all users selecting these categories for a friend. These System categories also include categories for the Social Networks and external systems which the System is connected to, examples including but not limited to Facebook and LinkedIn. There are also custom categories which may be created by a user. These are represented by elements 262, 265 and 268. These categories are only viewed by the user who created them. Each category will have a name as represented by elements 251, 254, 257, 260, 263, 266, 269. Each category has an owner. If it is a default category the owner ID is a System ID 252, 255, 258, 261 are examples of this. If the category was created by a user then the ID will be listed for the specific user 264,267,270. Only the category owner may see categories he created.

Referring to FIG. 9, a user will interact with a user settings screen a sample of which is shown in FIG. 9 in order to enroll in the System and manage their account settings. The user will enter in the required information such as; name, email address, account password and other demographic information which may be required by the system operator. The user will also configure their account with respect to automatically adding users to their System friends list, how and how often they wish to be notified of certain events and other system options. The user may have more than one account in the system if an account was created as a result of a system user sending a file to this user at a different email address or other identifier. The user may combine these different accounts via functionality on this user settings page.

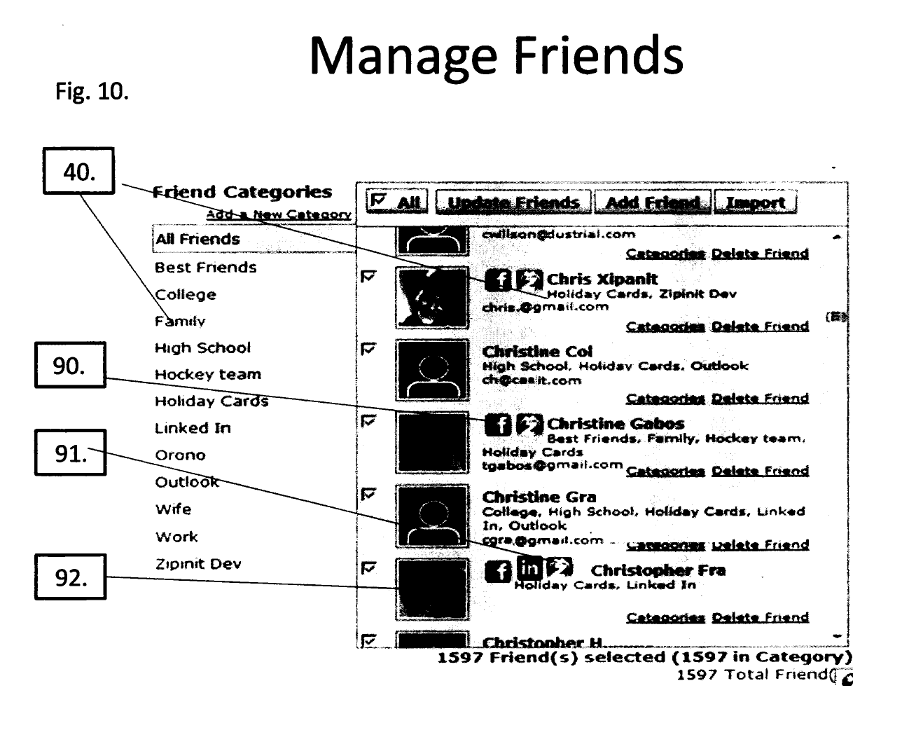

Referring to FIG. 10, once a user has joined the system, they have the option to add friend relationships to their System account. FIG. 10 is a sample of a screen where these actions may be performed. A user may add friend relationships to the System by manually by entering in a person's name and email address, by importing a list of people, or by adding their friend relationships which exist in the social networks 4 and 9 which are connected to the system as shown in FIG. 1. Element 40 displays categories which this user has assigned to a friend in their network. These categories will be referenced later in the description when explaining Album management options. Element 90, an example of an icon representing this contact, has an account in a particular Social Network which the System is integrated into. This icon may be represented in different ways such as different colors to further indicate whether the System user is linked to this contact in the specific network. Clicking on this Icon will launch a separate browser instance and connect to the social network displaying the page for this contact. The System user may be required to have his own account in the specific Social Network in order to view this page. Element 91 is an indicator representing that this user has activated their account in the System. Alternatively within the System, this icon may be presented nest to each contact and the contact's status within the System may be represented by a different color of this icon. Clicking on this icon can launch this contacts personal information page whereby this user can edit the information for the contact. Element 92 is representative of a picture of this friend which can be imported from a Social Network, or uploaded by the System user.

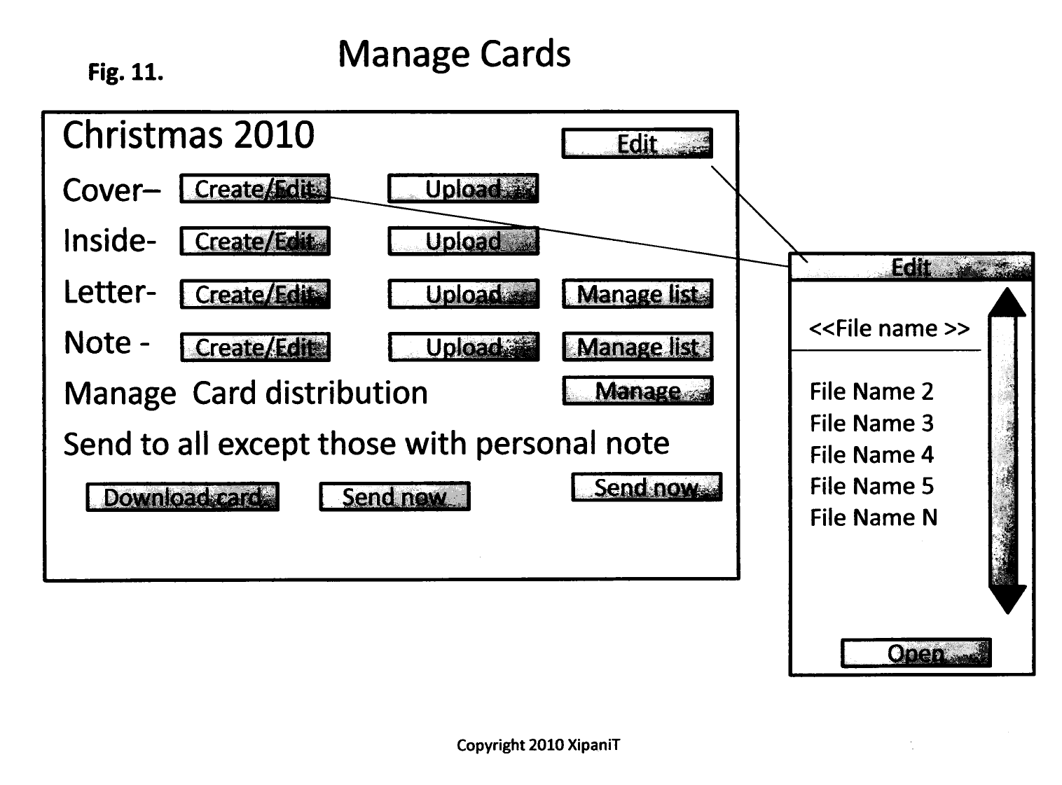

Referring to FIG. 11, throughout the patent application the word “files” is referenced to describe the digital files which can be uploaded and distributed through the System. The System is designed to create a significant user experience around certain types of files that may be related to specific events. The user screen shown in FIG. 11 relates to an experience enabled with the system around the creation and distribution of greeting cards and in this example, holiday cards such as are sent around Christmas and Hanukah. An objective of the system is for a user to upload a card and use the system to distribute this card to all of their friends who they wish to receive this card. A user may create a card or may upload one which they have previously created. On the user screen represented in FIG. 11 the user can create a card cover and text which would show inside the card. The card may be a simple picture card without any text on the inside. The user can attach a file (document) to this card which can also be distributed to this user's list of recipients. The user can manage the list of friends they wish to send this document file to. They may choose all friends or may select only a subset. As mentioned in FIG. 11, the user may manage the distribution of this additional document file so that it may be sent to a sub set list of users which does not include all the users who received the card file. There may be various preview steps through the sending process allowing the System user to add or delete members to the batch of friend recipients for this task as well as confirming the files to be sent.

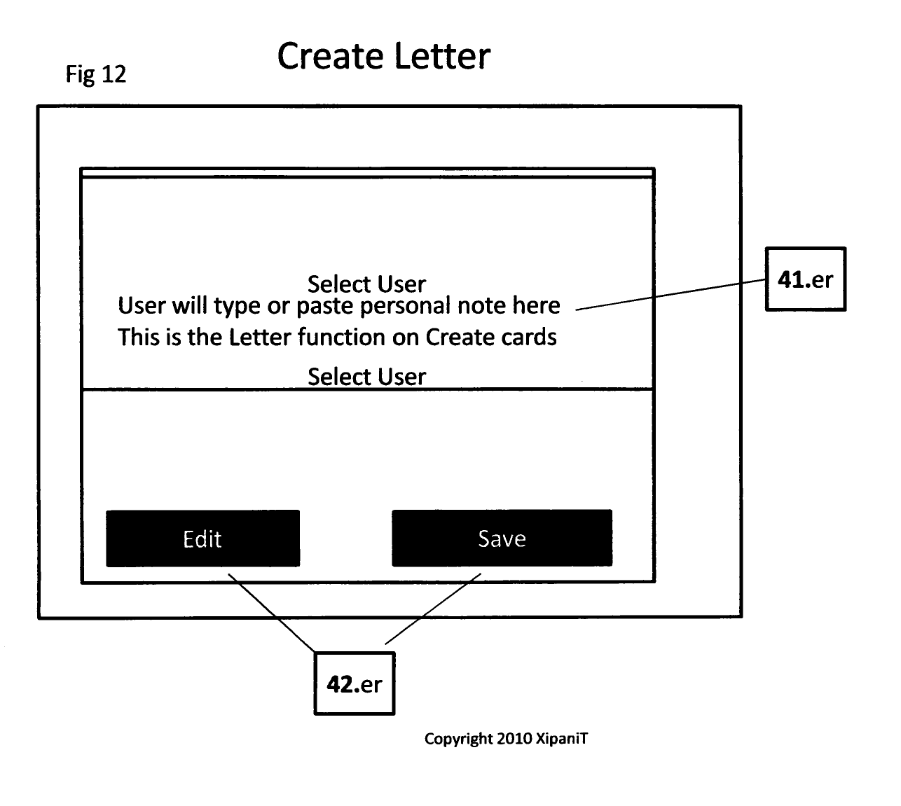

FIG. 12 is a sample user screen where a user can create and submit a letter for distribution as described previously during the description of FIG. 11.

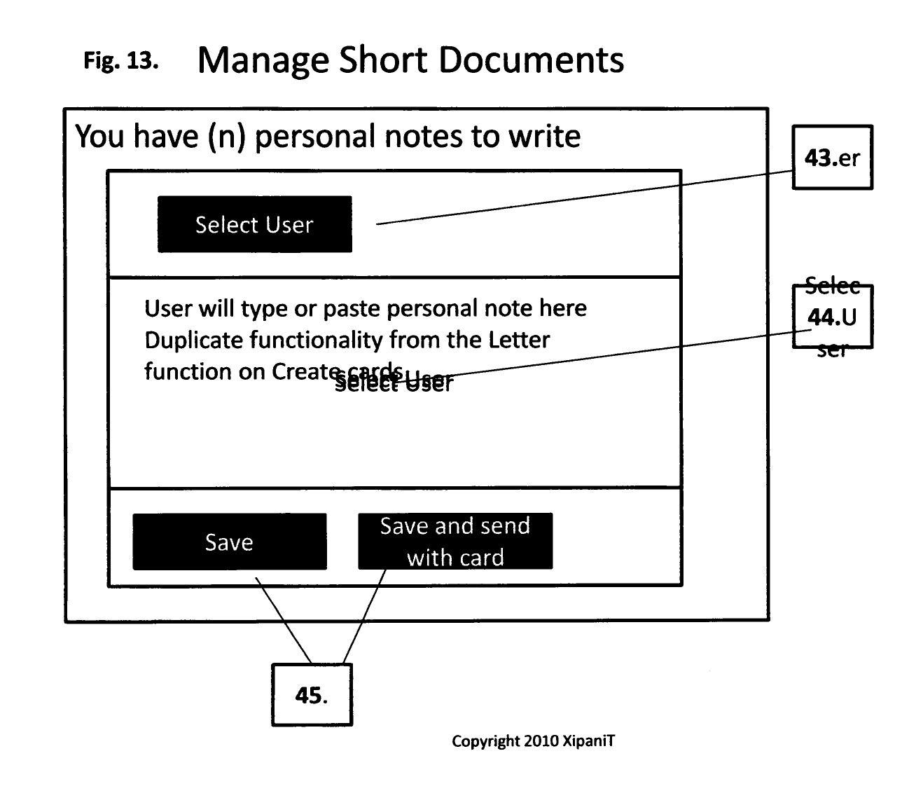

While FIG. 12 illustrates the ability of a user to write a letter for distribution to a list of friends, FIG. 13 illustrates the user's ability to send a more personalized note (short document) which would be intended for a select number of more personal friends. This “note” feature allows the user to attach a unique note (short document) for each person that they wish to send this note (short document) to.

FIG. 14 is a visual representation of how a card is presented to a recipient when a user has sent a letter 149 or 151 along to this specific recipient. In the lower right corner of the image is an indicator 46 that there is a letter accompanying this card file or indicator 47 if there is a note (short document) accompanying a card file. These visual elements would be made visible to the recipient only within the system. This indicator will only be visible to the recipient during certain portions of the application. When a user sees this indicator and clicks on it, the system will display the letter (long document) or note (short document). Similar indicators will be made visible for the other accompanying files which may be affiliated with the card file.

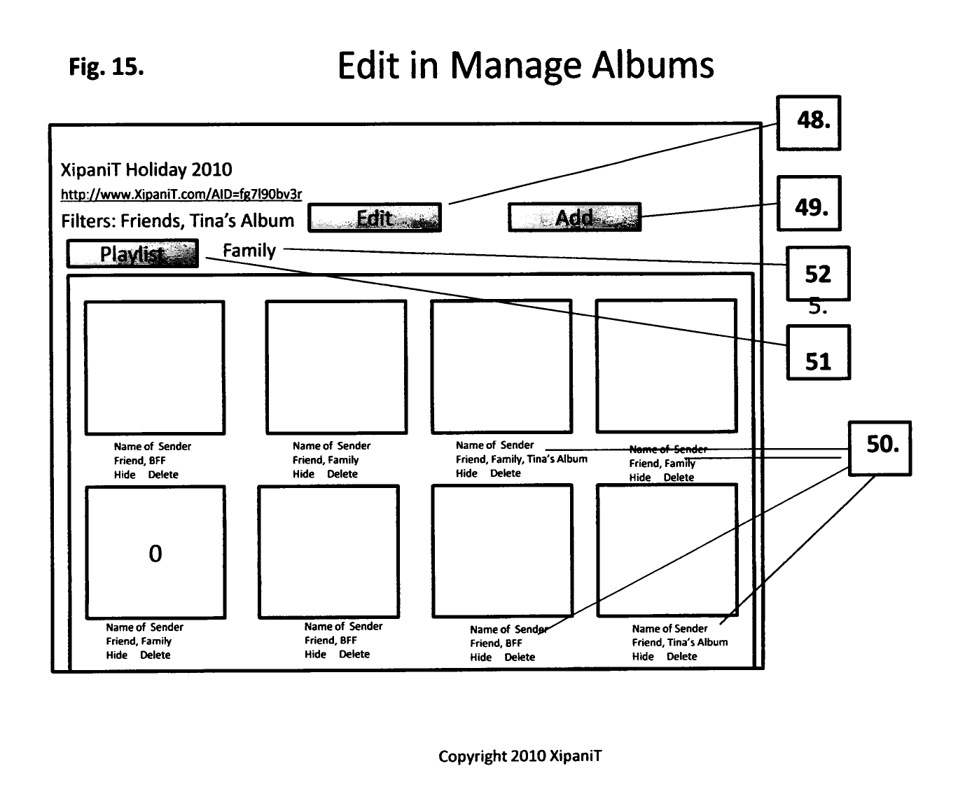

Referring to FIG. 15, one of the unique features of the system is that each recipient has the ability to manage the experience of the album without any of the file senders knowledge of how the recipient is treating the specific file (card). The recipient may manage the album using control 48 by hiding or deleting files, and may also filter the album only showing files from friends in certain categories 40 from FIG. 10. As an example, only showing files from “Family” or “Work” category friends. Users may also upload their own photos into an album where most of the files are contributed to the Album from within the System by clicking the Add control 49. Element 50 denotes the categories applied to a specific image. Element 51 is the play list control which launches the user into a form which allows them to create a play list of the files within the album. This playlist can be filtered on user criteria, dates or any other criteria tracked within the system.

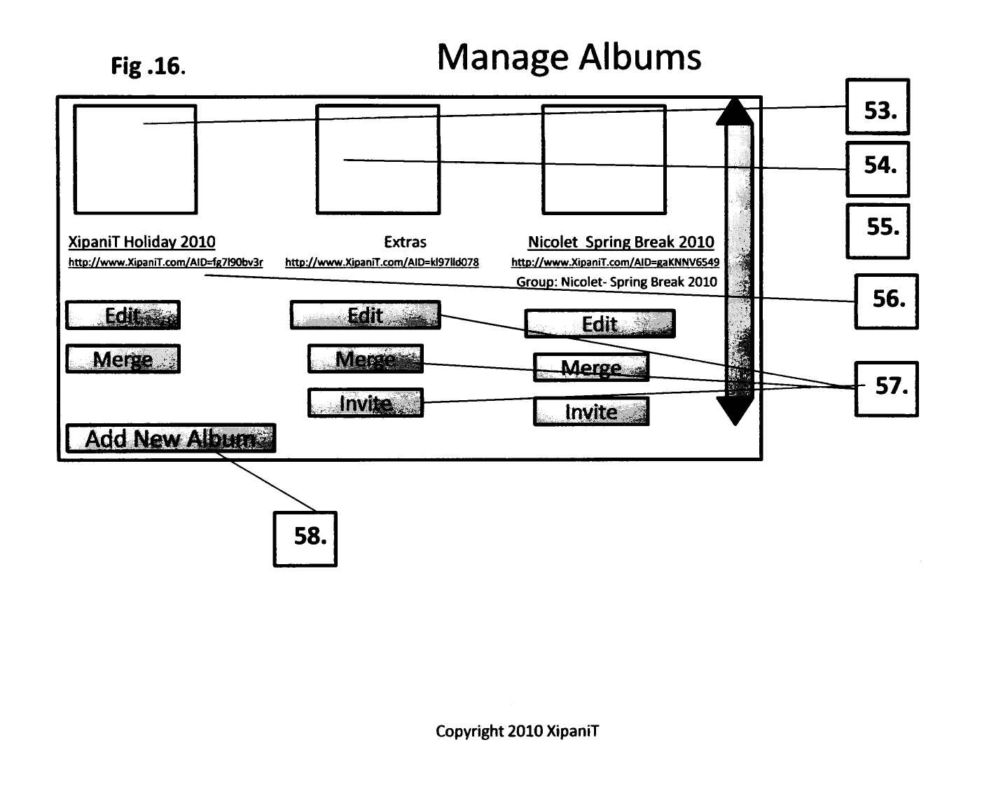

FIG. 16 is a sample of a user interface where a user can see all their albums and can perform the management functions with respect to creating albums and managing album sharing functions. Album 53 is an example of an album which is a default seasonal album created by the System. Album 54 is representative of a default album automatically created for each user account Element 55 is representative of a Group album. Element 56 is representative of a URL indicating where this album can be accessed on line outside of any social network. Elements 57 are representative of controls allowing users to edit their albums, merge albums with other members or invite members to join a group album. Element 58 allows a user to create a new Album. From within this feature a user may upload photos (files) into this album, or may import them from existing albums which they have rights to. One example around the Holiday card example would be for a user to import all cards received from a particular person which were received over a multi-year period into a single album.

FIG. 17 is representative of a user screen where a user can invite one of their friends to merge albums 61. In the event the two users agree, they can choose to sync one album into another, or they may elect a two way Sync where any file added to either album will show in both 62 to create two albums comprised with the same list of files. An example of this is where two people are married to each other and wish to have only one album where all of their Christmas cards (photos) are aggregated for viewing. Once the albums are combined, each user may still apply a filter hiding all files which were imported from the other album as shown previously in FIG. 15.

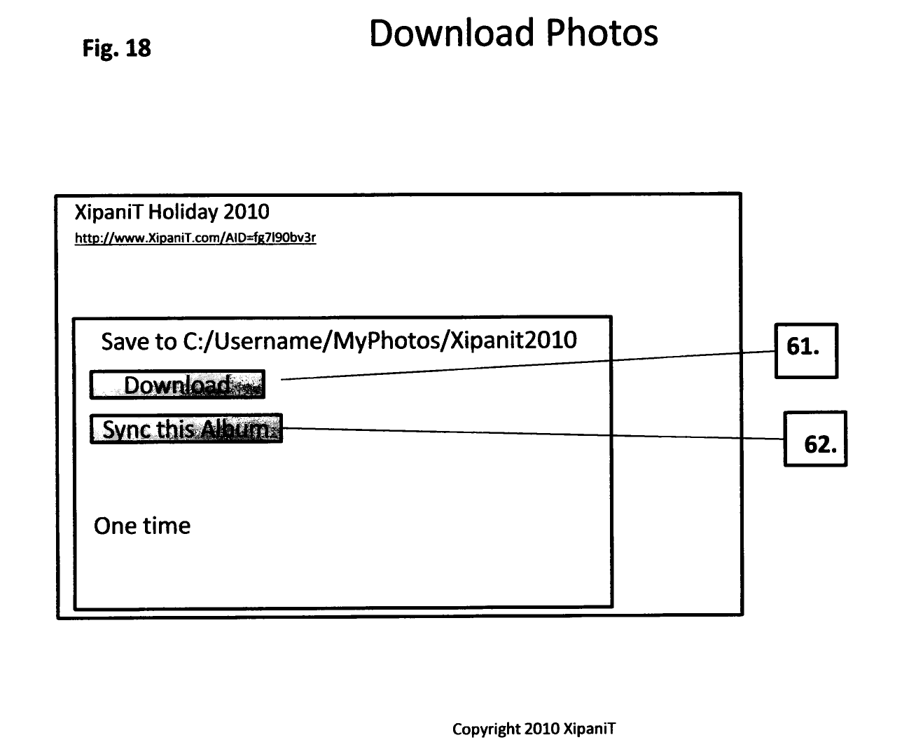

FIG. 18 is a representation of a screen where a user can manipulate the system to down load the files of an album to a local storage device 10 from FIG. 1. The user can set the System to download the entire album, or Sync to a local folder eliminating the need for a complete folder download each time the user wants to update the local storage of the files.

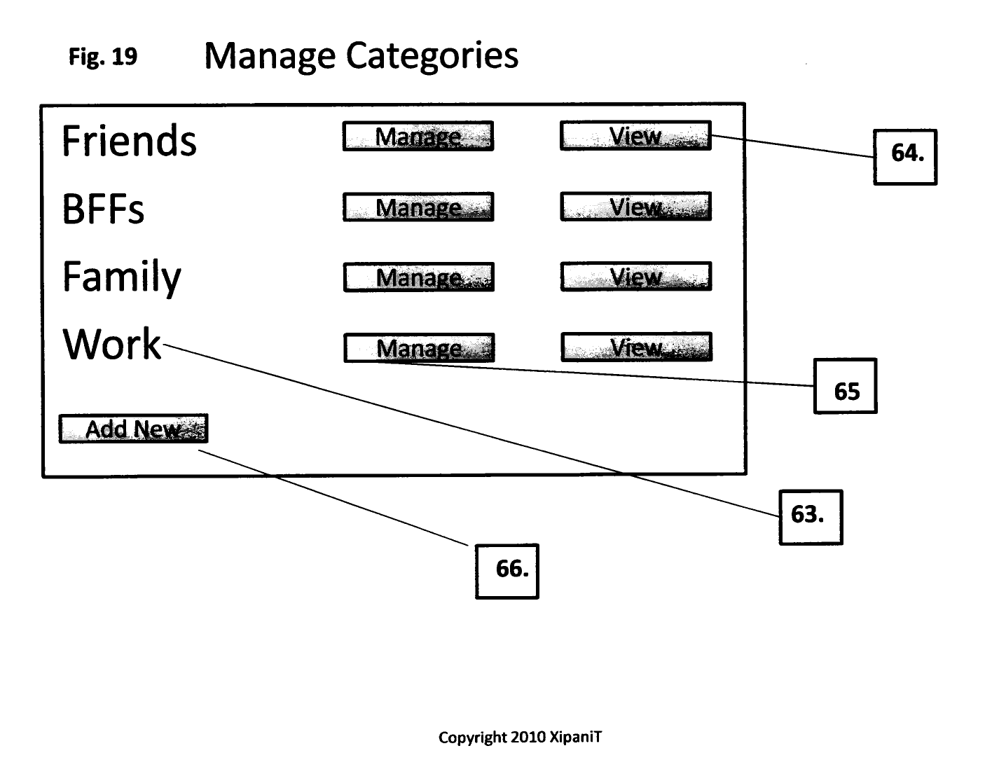

FIG. 19 is representative of a screen where a user can manage the categories for their Friends. Element 63 is the name of the category, Element 64 is the control to view the list of friends that are in a specific category, Element 65 is the control to manage users into a category and element 66 allows a user to create a category.

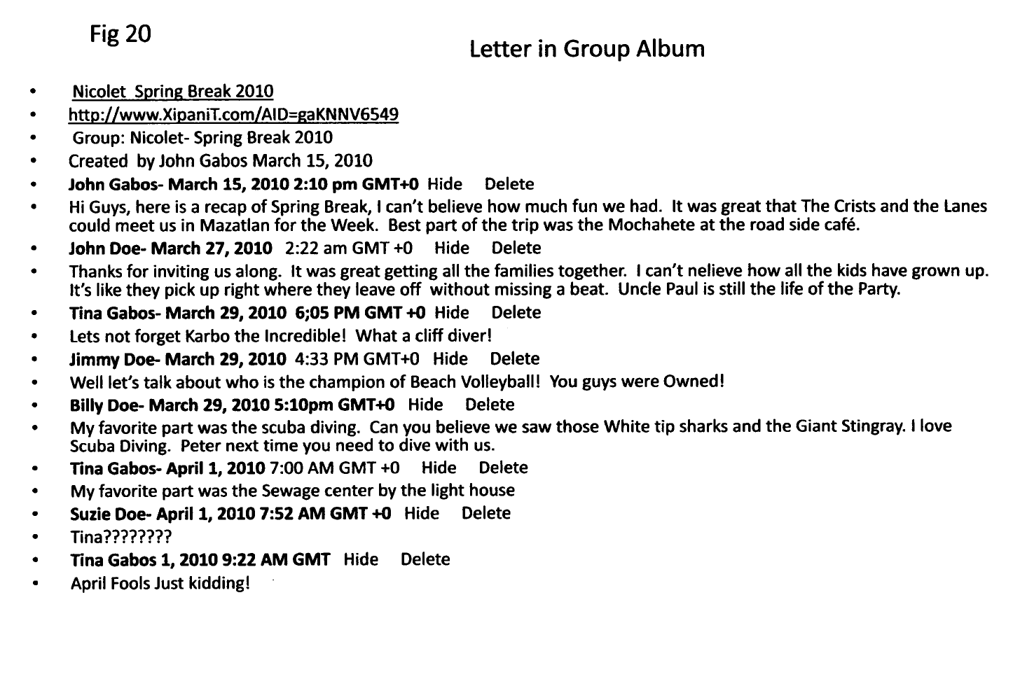

FIG. 20 is a sample of what a document would look like if it was part of an album which is set up as a group album. This document is editable by all members of the group. The unique feature of this document is that there is a virtual copy of this document in each user's version of the album. So each member may elect to hide or delete comments made by others. Any changes a user makes to their individual copy of the document are hidden to all of the other users who share this document.

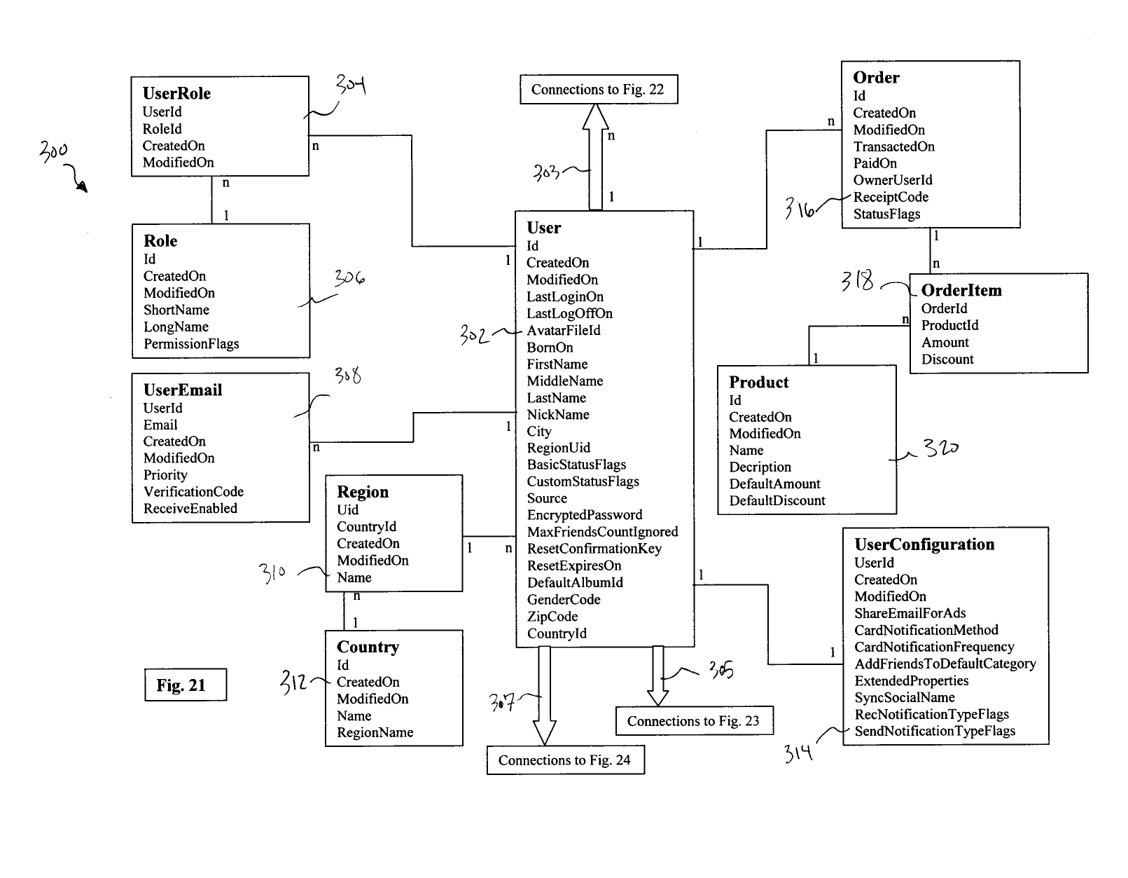

FIGS. 21-24 illustrate a database schema 300 utilized by embodiments of the present invention. For the purpose of describing the uniqueness of the System only those data elements which contribute to the illuminating of the invention are included, as there are many data elements which will be tracked and recorded and that are not mentioned in the detailed discussion of the figures included in this application. The absence of the disclosure of these elements in this application does not detract from the uniqueness of the disclosure, nor will the inclusion of additional elements in the actual System prohibit the present claims from being acknowledged and enforceable.

The database schema 300 illustrated by FIGS. 21-24 is stored in non-volatile memory such as RAM or ROM in the form of machine-readable code, implemented as a database computer declarative language designed for managing data in database management systems. In an embodiment, schema 300 is SQL-based. In another embodiment, schema 300 is DB2-based. In other embodiments, other declarative database languages are also considered. Database schema 300 is implemented by a processor configured to read schema 300 and draw from the related stored data. For example, schema 300 can be stored in the RAM of index server 21 and implemented by the processor of index server 21 by accessing the data stored in master index data 24. A computer program product is thereby produced, the computer program product comprising a computer usable medium having a non-transitory computer readable program code embodied therein, said computer readable program code adapted to execute schema 300.

Throughout schema 300, standard notations between individual tables represent the relationship among the tables. For example, User table 302 has a one-to-many relationship with UserRole table 304. Thus, in this one-to-many relationship, each row of User table 302 can be related to many rows in the relating table. User table 302 has a one-to-one relationship with UserConfiguration. In this one-to-one relationship, exactly one row in User table 302 is related to exactly one row in UserConfiguration. In some circumstances, a many-to-many relationship exists between a first table and a second table. However, such a relationship cannot be implemented directly in a relational database. In those instances, an intermediate table that records all combinations of the first table that exist with the second table is utilized. One skilled in the art will readily appreciate such a construction. For clarity and succinctness, the relationships between the tables are evident in FIGS. 21-24 and are generally not repeated here. Certain relationships are discussed, however. Additionally, in the embodiment depicted, every table within schema 300 comprises multiple elements. For clarity and succinctness, the individual elements within every table are evident in FIGS. 21-24 and are generally not repeated here. However, certain elements are discussed where appropriate.

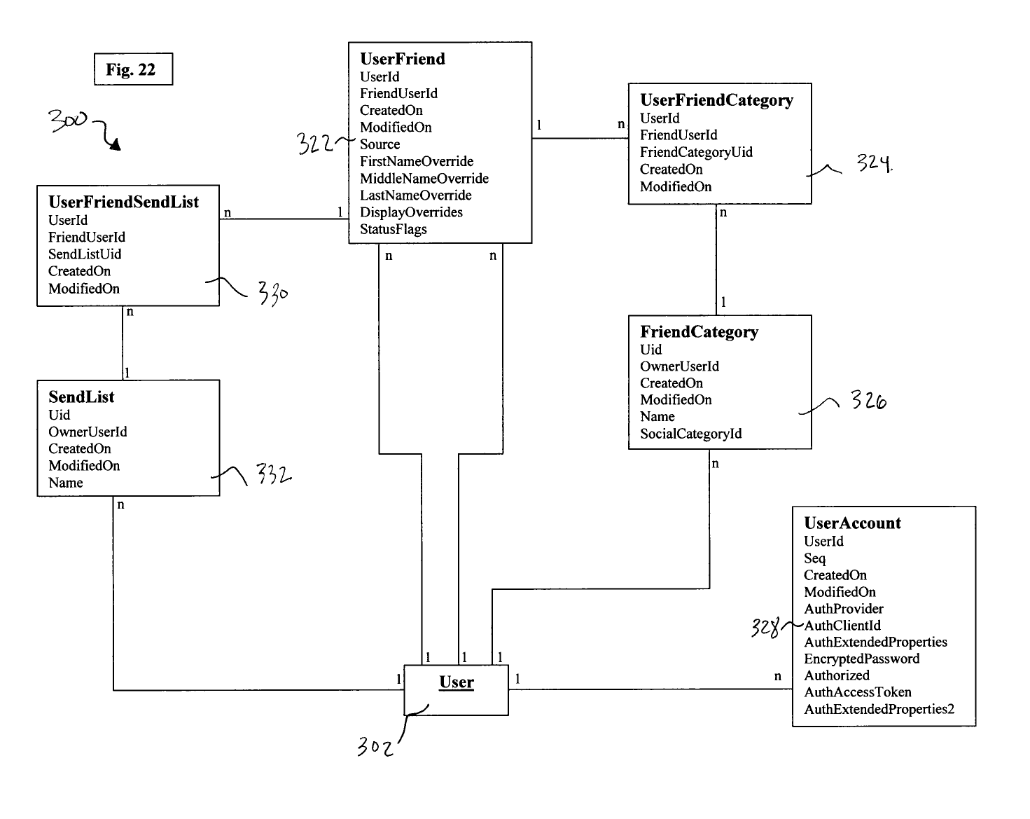

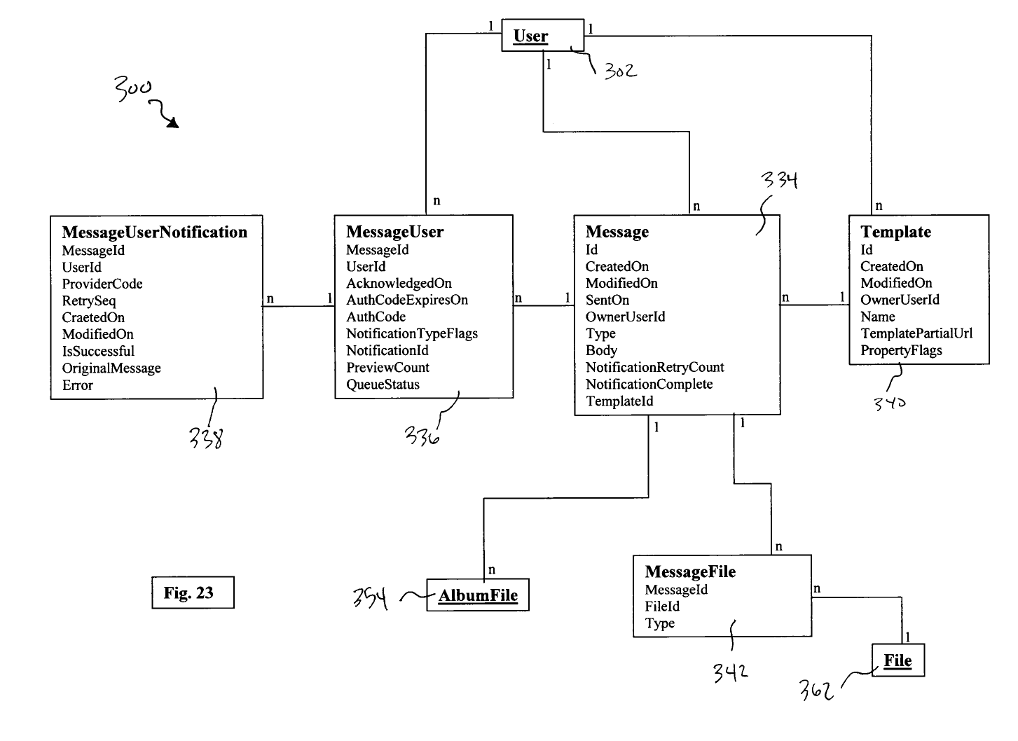

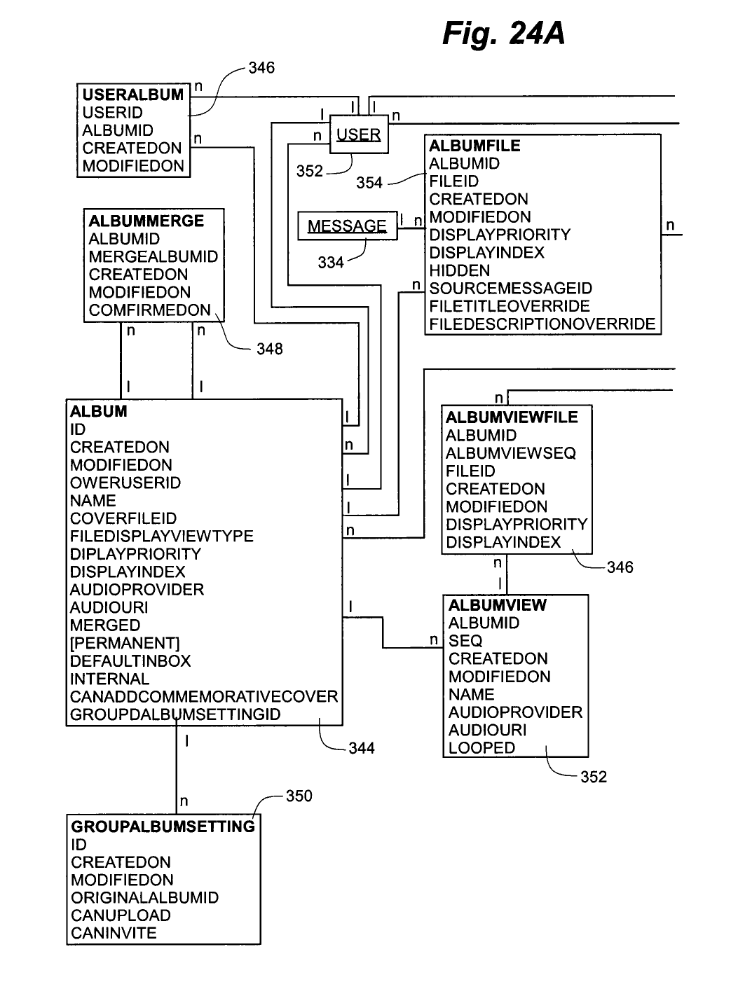

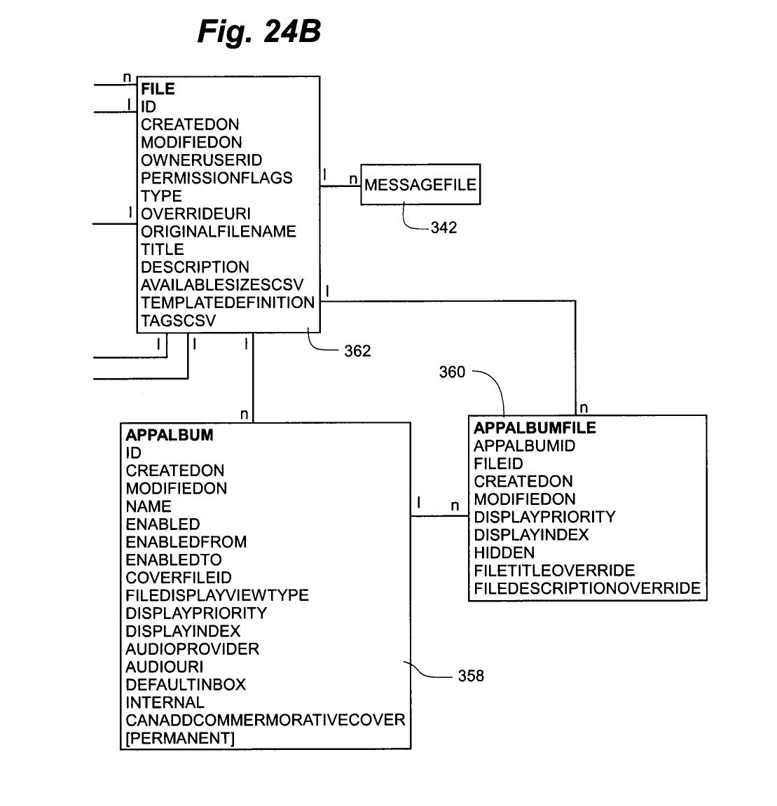

Referring specifically to FIG. 21, a user table 302 is a central table within schema 300. User table 302 includes basic user information and is linked to all other tables comprising user-specific information and rights. For ease of illustration, User table 302 is linked to tables in FIG. 22 via relation 303, to tables in FIG. 23 via relation 305, and to tables in FIG. 24 via relation 307. The respective relationships to User table 302 encompassed by relations 303, 305, and 307 are illustrated in FIGS. 22-24, where User table 302 is shown without all of its elements.

A UserRole table 304 includes a list of all possible roles available to relate to a particular user. In embodiments, examples of roles include, but are not limited to: user, administrator, enterprise user, enterprise administrator, business user, non-profit user, template manager, or standard user. User table 302 has a one-to-many relationship with UserRole table 304. As such, every instance of User 302 can be related to multiple roles defined by UserRole 304. In an example, a user is defined by a role as an enterprise user. As such, the user will have access to card templates that are specific to that particular enterprise and tailored for the user's role in that enterprise. For example, the enterprise may be an insurance company, with card templates having the company's logo on them. The specific insurance company templates would thus be hidden from users that are not in the role required to access that specific enterprise card template. In other examples, various other users can access public or private card templates, depending on their respective roles.

A Role table 306 includes the rights or permissions of each UserRole 304. Specifically, instances of element PermissionFlags within Role table 306 are evaluated to give a particular instance of User 302 having a particular Role 304 access (or denial, as appropriate) to features within the system.

A UserEmail table 308 includes an email addresses for every instance of User 302, and includes the status of that email address, such as whether the email address is the user's primary address, and whether the address has been verified by the user. Every User 302 may have multiple addresses, as denoted by the one-to-many relationship between User 302 and UserEmail 308.

A Region table 310 includes a User 302 region. Country table 312 further includes a country within the region of Region table 310. Therefore, locality information can be stored for a particular user.

A UserConfiguration table 314 includes system settings for each User 302. As illustrated by the one-to-one notation, exactly one instance of UserConfiguration 314 defines the settings for one instance of User 302. Thus, settings are uniform for a particular user. Such settings control how the system behaves for a particular user. For example, the element CardNotificationMethod can specify “Facebook” or “email” to direct various elements of the system to notify a user, by those respective methods, that a new card is waiting to be viewed.

An Order table 316 includes orders placed by a particular user, and includes basic ordering information about an order a user has placed. As such, every order is further defined by an OrderItem table 318 and a Product table 320. OrderItem 318 includes a list of the items in an order. Every product can be related to multiple orders, and every user can place multiple orders.

Referring specifically to FIG. 22, tables relating to contact organization are depicted.

A UserFriend table 322 includes a list of all contacts a user has imported or added. Overriding entries in UserFriend table 322 allows user attributes to be displayed differently for the originating user without affecting how other users throughout the system view the attributes.

A UserFriendCategory table 324 includes a list of all of the categories a particular friend is categorized in by a user.

A FriendCategory table 326 includes all types of the groups in which a contact can be classified. FriendCategory thus includes the categories a particular user has created, as well as, in some embodiments, default categories created by the system. For example, categories can include but are not limited to: “LinkedIn,” “Salesforce.com,” and “Facebook,” based on how the contact was imported to the system. Further, the system may predefine “friend,” and “family,” in embodiments. Thus, UserFriendCategory 324 may categorize a single contact to “Facebook” and “family” because the contact was imported by the Facebook API from Facebook, and is a member of the user's family.

A UserAccount table 328 includes elements for authenticating a user in the system based on information received from an outside application. Information about a user from a social network or other external service is also distributed to or received from the external service. In embodiments, UserAccount table 328 can be utilized with Facebook, LinkedIn, and Salesforce.com. An instance of UserAccount table 328 exists for each external service.

A UserFriendSendList table 330 includes a list of friends selected from different groups to whom a send item can be sent. For example, a send item could be a particular greeting or announcement by a user.

A SendList table 332 includes a name of a particular send event and can include other send event details. SendList table 332 acts like an invitation group or distribution group.

Referring to FIG. 23, messaging relations and recordations are illustrated. Message table 334, the primary messaging-related table, includes a record of send items sent by a user. Message table 334 further records the details of any messages, such as which file was used in the message and anybody of the message. Examples of messages or send items include pictures, videos, electronic cards, or any other computer-readable file a user has uploaded into the system.

A MessageUser table 336 includes all system users who are recipients of a particular send item.

A MessageUserNotification table 338 tracks and records the viewing results of a particular message. For example, MessageUserNotification 338 tracks that once sent to a particular user, that user logged in and viewed the message successfully.

A Template table 340 includes the template used for a particular message. Template table 340 drives what a particular message or send item looks like.

Referring to FIG. 24, album relations are illustrated. As mentioned above, albums can comprise a collection of files, where files can comprise photo images, videos, or other documents, like electronic cards. The primary table concerning albums is the Album table 344. Each album within Album table 344 has a unique ID. Every user can have one or more albums, as shown by the one-to-many relationship between User 302 and Album 344. Every album is linked via album ID to a user ID.

A UserAlbum table 346 includes the basic information for each album. In embodiments, this basic information can include the user ID for the user creating the album and the various rights permitted under this album. UserAlbum 346 further includes a list of all albums a particular user has. Thus, the relationship between User table 302 and UserAlbum table 346, combined with the relationship between UserAlbum table 346 and Album 344 allows for such data.

An AlbumMerge table 348 includes a set of albums that should be experienced as a singular album by the viewing user. The resulting set of files from such a singular album is the union of all the files of all the albums that an instance of AlbumMerge 348 references. In effect, AlbumMerge 348 creates a parent album to give a multi-album view.

A GroupAlbumSetting table 350 includes configurations allowed by the creator of the album, and particularly whether an album is a private album or group album. In an embodiment, the existence of a GroupAlbumSetting 350 record for a specific Album record denotes that such an album is a group album. In that embodiment, all albums without a GroupAlbumSetting 350 record are treated as private albums. In the instance GroupAlbumSetting 350 does exist, a virtual album is created for every instance of the user allowed by the group. Individual copies of the album are thus created, allowing for manipulation by individual users of their respective albums, without the same manipulation reflecting on the copies of the album of the other members of the group.

An AlbumView table 352 includes the information for a particular viewing event or slideshow created for a particular album. AlbumView table 352 contains information about the order files will be played, speed of the file rotation, and audio files which might be played along with the slideshow or view. Effectively, AlbumView table 352 is the “view” into the album.

An AlbumViewFile table 356 includes the view information of a file. For example, the order of the files to be presented within the album and if they should be presented or hidden from view are elements in AlbumViewFile 356. AlbumViewFile can also include a list of views into the album, or a list of slideshows that are possible for viewing the album. Further, AlbumViewFile 356 also includes the list of files within a specific AlbumView 352.

An AlbumFile table 354 includes details of how a particular file is treated in a particular album. For example, elements of AlbumFile 354 can include whether a file is hidden, or has been deleted from a particular album. AlbumFile 354 further forms the collection of files in a specific album.

An AppAlbum table 358 includes the information to create new albums. AppAlbum table 358 serves as a template of Album table 344 values, which are generally used when a new user is added to the system and receives a default set of albums. The set of albums are derived from this table.

An AppAlbumFile table 360 serves as the template for AlbumFile 354 records that are created in conjunction with the creation of a new album. Some albums created by the system allow the user to enjoy the experience of an album without requiring the upload of any files.

A File table 362 includes information for each file uploaded into the system. File 362 links to the repository where the file is kept. In the card context, a card is also created as an instance of File 362.

Referring again to FIG. 23, a MessageFile table 342 acts as an intermediary between Message 334 and File 362. In an embodiment, where one copy of a file is stored in the system, MessageFile 342 includes the reference to the particular file.

Embodiments of the present invention may be better understood by consideration of the following flowcharts. The following algorithms can be implemented by the system of various processors described above, as stored in the form of machine-readable code by non-volatile memory of the system.

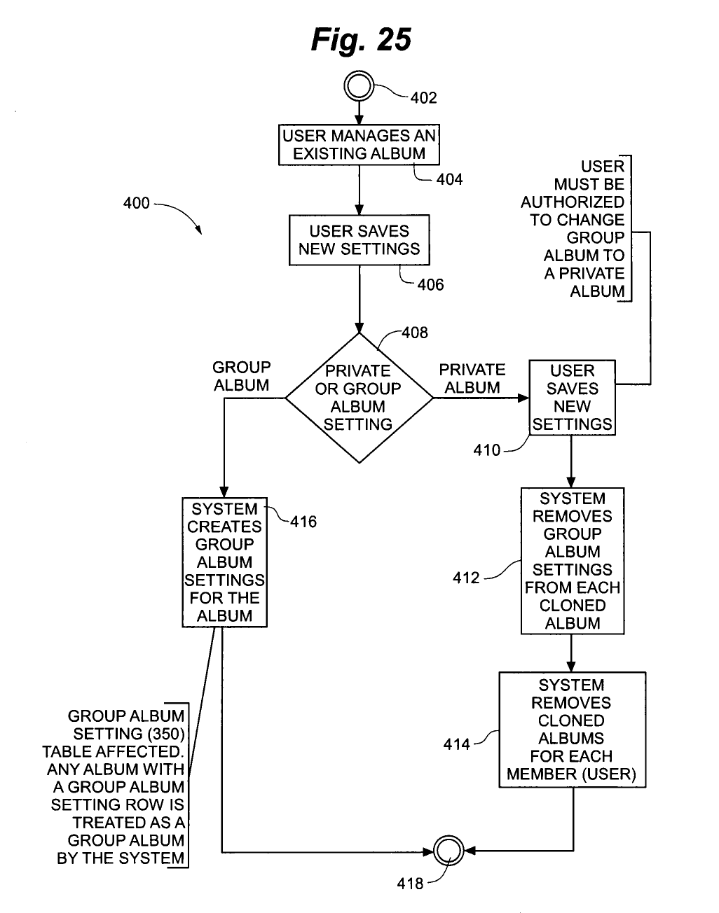

Referring to FIG. 25, a method of managing an album 400, according to an embodiment, is depicted. At starting point 402, the method begins with a user operating within the system, the system having at least one album managed by the user. At 404, the user elects to manage the at least one existing album. At 406, the user elects new settings. Based on the elected settings of 406, the system responds with corresponding behavior in order to set properties of the at least one existing album. At decision point 408, the system interprets the user's decision to make the at least one existing album public or private. If a private album at 408, the settings are saved at 410. Note that in order for the setting to be saved, the user must be authorized to change an album already configured as a group album to a private album. At 412, the system removes the group album settings from each of the cloned albums for each user in the group. At 414, the system removes the cloned albums for each user in the group. At 418, the method ends, having converted a group album to a private album. If, however, returning to 408, the at least one album is converted to a group album at 408, the system establishes group album settings for the album at 416. Effectively, a record of GroupAlbumSetting 350 is created. Any album with a GroupAlbumSetting 350 row is treated as a group album by the system. The method then ends at 418, having converted a private album to a group album. Note that in embodiments, the cloned albums are created for every member of the group at the time a subsequent group album invitation is sent. In other embodiments, the cloned albums are created for every member of the group at the time the group album invitation is accepted by a group user. In other embodiments, the cloned albums are created for every member of the group still after acceptance.

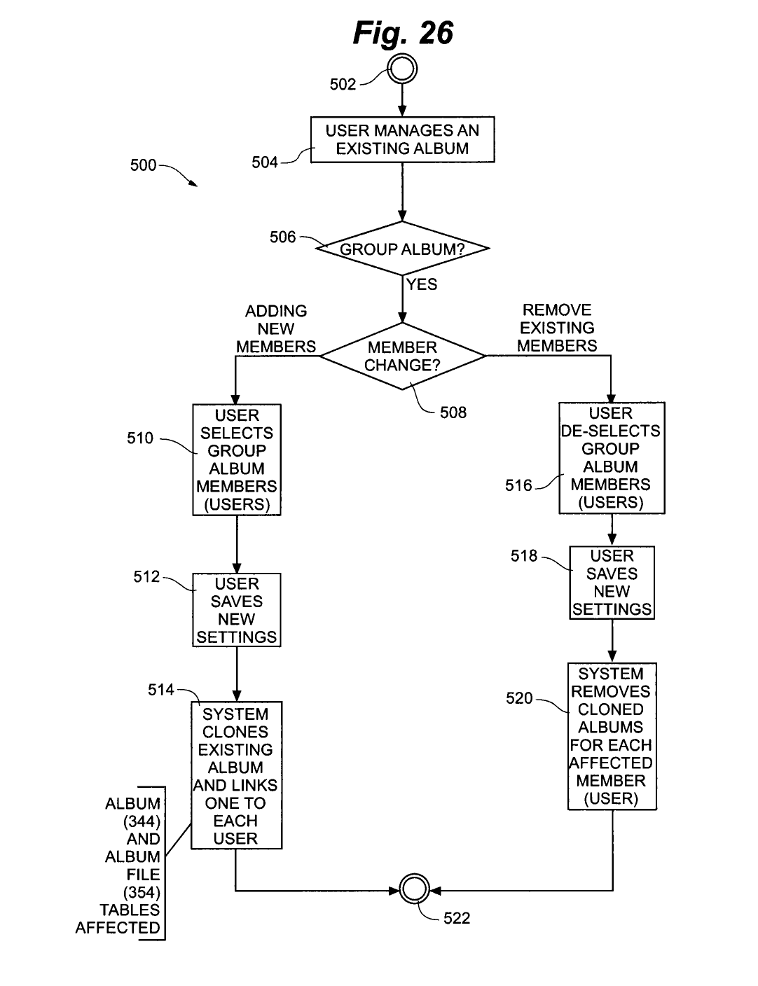

Referring to FIG. 26, a method of managing a group album 500, according to an embodiment, is depicted. At starting point 502, the method begins with a user operating within the system, the system having at least one album managed by the user. At 504, the user elects to manage the at least one existing album. At 506, the system confirms with the user that the album being managed is, in fact, a group album. If, at 506, the album is not a group album, the private album can be converted to a group album using the method of creating an album 400 described in FIG. 25. At decision point 508, the user elects a member change to the group album. If members are being added at 508, the managing user selects various contacts from among the managing user's contacts as members to add to the group album. At 512, the managing user saves the new settings, including the collection of new group members. At 514, the system clones the existing album and links one to each user to create virtual albums for each new group member. Note that at 514, entries and/or instances of Album table 344 and AlbumFile table 354 are thereby modified. At 522, the method ends, having added members to a group album and created virtual albums for the new group members. If, however, returning to 508, members are being removed at 508, the user selects various group members from among the group members. At 518, the managing user saves the new settings, including the collection of removed group members. At 520, the system removes the cloned virtual albums for every selected group member. At 522, the method ends, having removed members from a group album and thereby removed the previously-existing virtual albums for the selected members.

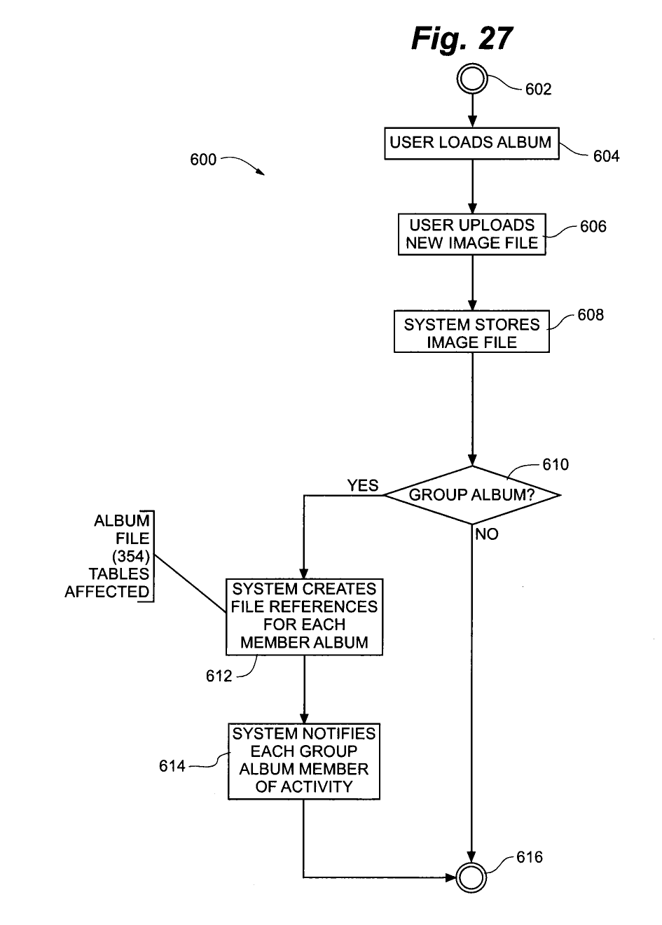

Referring to FIG. 27, a method of sharing in a group album 600, according to an embodiment, is depicted. At starting point 602, the method begins with a user operating within the system. At 604, the user loads an album. In an embodiment, the album may be already-existing. In another embodiment, the album may be newly-created by the user. At 606, the user uploads a new image file. At 608, the system stores the file image. The store can be done in volatile or non-volatile memory, as convenient for the system. If in volatile memory, a subsequent store to non-volatile memory must also be executed. Entries and/or instances of AlbumFile table 354 and File table 362 are thereby modified. At 610, if the album is not a group album, the method proceeds to the method end 616. If, however, returning to 610, the album is a group album, cloned virtual albums for every group member have already been created and disseminated to the group members. The method proceeds to 612, whereby the system creates file references for each of the cloned virtual albums. Entries and/or instances of the AlbumFile table 354 are thereby modified. At 614, the system notifies each group album member of the file sharing activity. In an embodiment, the notification at 614 can be implemented by the messaging relations depicted in schema 300 by FIG. 23. At 616, the method ends, having added a new file to a group album, modified the virtual albums of each group member, and notified the group members of the file addition.

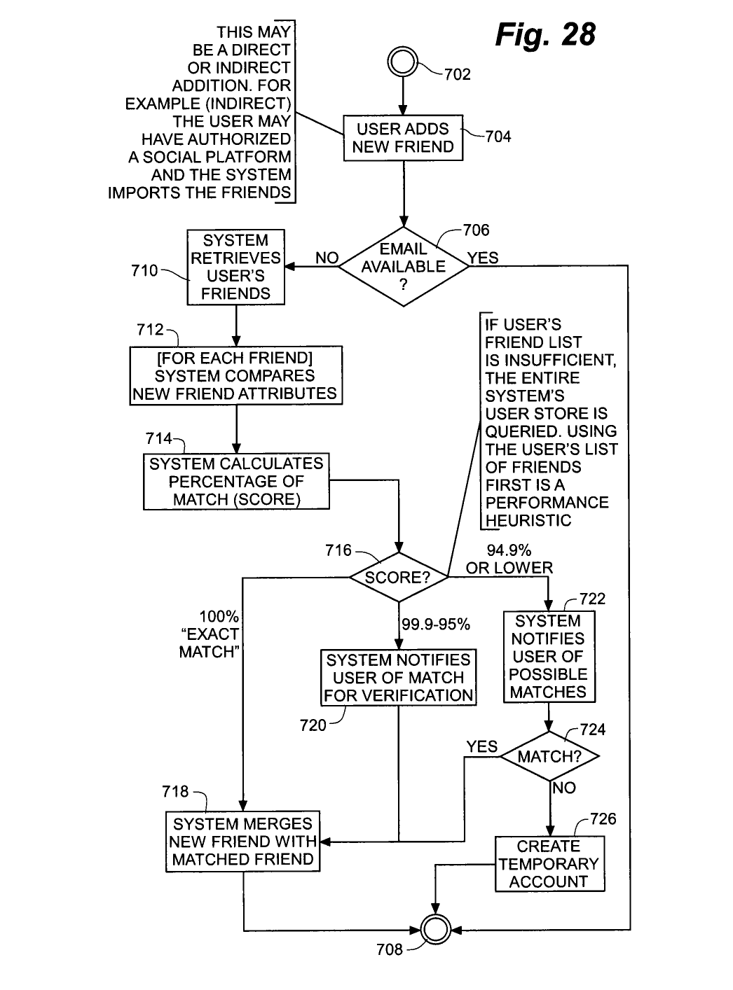

Referring to FIG. 28, a method of user reconciliation 700, according to an embodiment, is depicted. At starting point 702, the method begins with a user operating within the system. At 704, the user adds a new contact to the aggregated contact list. The addition may be a direct or indirect addition. For example, in an indirect addition, the user may have authorized a social platform to export contacts to the system, and the system subsequently imports the contacts. At 706, the system checks whether an email address is available for the newly-added contact. If an email address is available, the method proceeds to method end 708, as the email address is sufficient to uniquely identify the newly-added contact. If, however, returning to 706, an email address is unavailable for the newly-added contact, the system retrieves the user's other contacts at 710. At 712, the system compares any imported attributes the newly-added contact may have against the attributes of each existing contact. At 714, the system calculates a score related to the percentage of attributes that match between the newly-added contact and the existing contacts. At 716, the score is evaluated. Note that steps 712, 714, and 716 are recursive, as the newly-added contact is compared one-by-one against the attributes of each existing contact. If, at 716, the attributes between the newly-added contact and an existing contact comprise a 100% “exact match,” the system merges the newly-added contact with the matched contact at 718. The method then proceeds to method end 708. If, at 716, the attributes between the newly-added contact and an existing contact comprise a 99.9% to 95% match, the system notifies the user of a match for user verification at 720. If verified, the system merges the newly-added contact with the matched contact at 718. The method then proceeds to method end 708. If, at 716, the attributes between the newly-added contact and an existing contact comprise a less than 94.9% match, the system notifies the user of a possible match at 722. If, at 724, the user denies the match, or if the attribute matching reaches a lower threshold, the system creates a discrete temporary account for the contact. The method then proceeds to method end 708. If, however, at 724, the user affirms the match, the system merges the newly-added contact with the matched contact at 718. The method then proceeds to method end 708.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A method of distributing at least one digital file to a group, the group comprising a plurality of group members and managed by a managing user, the method comprising:
generating an album for the managing user, the album comprising the at least one digital file by operation of a processor invoking space on an attached non-volatile memory;
receiving, from the managing user, data related to the plurality of group members;
generating, based on the data related to the plurality of group members, a copy of the album for each of the plurality of group members, thereby creating a virtual album for each of the plurality of group members; and
linking the copy of the album created for each of the plurality of group members to each of the plurality of group members.

2. The method of claim 1, further comprising a group member contributing files to their virtual album and references to those files being applied accordingly to the plurality of group members albums in order for the plurality of members to view the file.

3. The method of claim 1, further comprising a group member manipulating the viewing experience of their virtual album without modifying the virtual albums of the plurality of the group members.

4. The method of claim 1, further comprising sending an invitation to the plurality of group members related to the album based on the data related to the plurality of group members.

5. The method of claim 4, wherein the virtual album is created at the time the invitation is sent.

6. The method of claim 4, further comprising receiving an acceptance for the invitation from the plurality of group members.

7. The method of claim 6, wherein the virtual album is created at the time the acceptance is received.

8. The method of claim 1, further comprising:
receiving, from the managing user, data related to removal of at least one of the plurality of group members from the group; and
deleting the virtual album for the at least one of the plurality of group members based on the data related to removal of at least one of the plurality of group members.

9. A computer program product, comprising a computer usable medium having a non-transitory computer readable program code embodied therein, said computer readable program code adapted to be executed to distribute at least one digital file to a group, the group comprising a plurality of group members and managed by a managing user, the method comprising:
generating an album for the managing user, the album comprising the at least one digital file by operation of a processor invoking space on an attached non-volatile memory;
receiving, from the managing user, data related to the plurality of group members;
generating, based on the data related to the plurality of group members, a copy of the album for each of the plurality of group members, thereby creating a virtual album for each of the plurality of group members; and
linking the copy of the album created for each of the plurality of group members to each of the plurality of group members.

10. A system of distributing digital files among a plurality of users into a private, single-user-controlled album, the system comprising:
a database schema configured to manage digital file data in a storage infrastructure, the digital file data configured to be grouped into albums referenced to selected users;
a storage infrastructure comprising memory configured to store the database schema, data related to the distribution of digital files, and the digital files; and
a processor configured to execute algorithms utilizing the database schema, the data related to the distribution of digital files, and the digital files.

11. The system of claim 10, wherein the processor is further configured to receive a digital file from one of the plurality of users and store the received digital file in the storage infrastructure which references to the received digital file only for intended recipients in the contact set of the one of the plurality of users.

12. The system of claim 11, wherein the processor is further configured to receive a digital file from the one of the plurality of users and create references to the received digital file for intended recipients who have been previously grouped or organized based on criteria set by the one of the plurality of users.

13. The system of claim 10, wherein the processor is further configured to receive a digital file from one of the plurality of users and the received digital file has an accompanying file which can be referenced to the recipient along with the original file.

14. The system of claim 10, wherein the processor is further configured to automatically generate an album.

15. The system of claim 10, wherein the processor is further configured to generate an album based on an album generation request of a user.

16. The system of claim 15, wherein the processor is further configured to receive a group album request, the group album request defining members of a group with whom the album is to be shared.

17. The system of claim 15, wherein the processor is further configured to generate a copy of the album for each of the members of the group.

18. The system of claim 10, wherein the processor is further configured to generate a file based on input received from at least one of the plurality of users, the file comprising a digital card.

19. The system of claim 10, wherein the processor is further configured to generate a slideshow of digital files.

20. The system of claim 19, wherein the processor is further configured to generate the slideshow based on user-selected criteria.

21. The system of claim 19, wherein the processor is further configured to play music during the slideshow.

22. The system of claim 10, wherein the processor is further configured to store, in the storage infrastructure, contact data uploaded by each specific user for each of the plurality of users and display only the individual contact data belonging to each of the plurality of users and hide the contact data of the remaining plurality of users.

23. The system of claim 22, wherein the processor is further configured to receive a privacy setting from a user, the privacy setting comprising a visibility level, the visibility level controlling the access of other users to view the contacts of the user.

24. A method of aggregating contacts into a combined contact set of a user, the method comprising:
receiving a contact addition, the contact addition comprising contact information for a contact;
retrieving the contact set of the user as well as the contact data of the plurality of users;
calculating a percentage score between each of the contacts in the combined contact set and the contact addition, the percentage score being a reflection of the percentage of attributes that match between a contact in the combined contact set and the contact addition;
interpreting the score; and
merging the contact addition with the matching contact in the combined contact set if the score is a 100% match,
notifying the user of a match for verification if the score is between a 95-99.9% match and merging the contact addition with the verified contact if verified,
notifying the user of a possible match if the score is less than a 94.9% match, and
creating a temporary account for the contact if there is no match.

25. The method of claim 24 wherein receiving a contact addition comprises a direct import of a contact by the user or an indirect import of a contact via a third-party platform

26. The method of claim 24, further comprising monitoring the third-party platform and identifying the presence of a member of the user's contact set within the third party platform, identifying the status of a relationship between the contact and the user within the third-party platform, and presenting an indicator identifying the contact's presence within the third-party platform, thereby further delineating the relationship status of the contact with the user within the third-party platform.

27. The method of claim 26, further comprising launching a browser when the user clicks on the indicator and presenting the contact's information page within the third party platform.
